(19) United States
(12) Patent Application Publication
(10) Pub. No.: US 2011/0187942 A1
(43) Pub. Date: Aug. 4, 2011

(54) LIGHTING DEVICE, DISPLAY DEVICE AND TELEVISION RECEIVER

(75) Inventor: Shiyoshi Cho, Osaka (JP)

(73) Assignee: SHARP KABUSHIKI KAISHA, Osaka-shi, Osaka (JP)

(21) Appl. No.: 13/121,230

(22) PCT Filed: Jun. 19, 2009
(86) PCT No.: PCT/JP2009/061209

§ 371 Date: Apr. 22, 2011

(30) Foreign Application Priority Data
Sep. 30, 2008 (JP) 2008-254922

(51) Int. Cl. H04N 5/66; F21V 8/00; G02F 1/13357

(52) U.S. Cl. 348/739; 362/628; 362/622; 362/613; 362/612; 349/65; 348/E05.133

(57) ABSTRACT

A backlight unit 12 includes LEDs 16 and alight guide plate 18. The LEDs 16 includes a light emitting surface 16a. The light guide plate 18 includes a light entrance surface 34 disposed so as to face the light emitting surface 16a and through which light from the light emitting surface 16a enters and a light exit surface 34 through which the light exits. The light emitting surface 16a and the light entrance surface 34 are formed to be curved and an AR coating process is performed on the light entrance surface 34 as an optical process. An AR coating layer 47 is formed on the light entrance surface 34. Accordingly, improved brightness is achieved.

### TECHNICAL FIELD

The present invention relates to a lighting device, a display device and a television receiver.

### BACKGROUND ART

In recent years, displays of image display devices including television receivers are shifting from conventional cathode-ray tube displays to thin-screen displays including liquid crystal panels and plasma display panels. With the thin-screen displays, thin image display devices can be provided. A liquid crystal display device requires a backlight unit as a separate lighting device because a liquid crystal panel used therein is not a light-emitting component. The backlight unit may be a direct-type backlight unit or an edge-light type lighting unit each having a different structure.

To reduce the thickness of the liquid crystal display device, it is preferable to use the edge-light type backlight unit. Patent Document 1 discloses such a backlight unit. The liquid crystal display device includes an LED and a light guide plate. The LED includes a light emitting surface that emits rays of light along a direction substantially parallel to a display surface of a liquid crystal panel. The light guide plate includes a light entrance surface and a light output surface. The light entrance surface is provided at the side edge of the light guide plate so as to be opposed to the LED and rays of light emitting from the LED enters the light entrance surface. The light output surface is provided on a front surface of the light guide plate and the rays of light output from the light output surface toward the display surface of the liquid crystal panel. A scattering pattern and a reflection sheet are formed on a lower surface of the light guide plate that is a surface opposite from the light output surface. The scattering pattern is provided to scatter the rays of light and the rays of light reflect off the reflection sheet. Accordingly, a uniform in-plane brightness distribution can be achieved on the light output surface.

[Patent Document 1] Japanese Unexamined Patent Publication No. 2006-108045

### Problem to be Solved by the Invention

In the above-mentioned backlight unit, gaps in predetermined sizes may be provided between the light emitting surface of the LED and the light entrance surface of the light guide plate due to the following reasons. When the light guide plate is assembled to an LED board on which the LEDs are mounted, assembling errors are inevitably caused. If no gap is provided therebetween, the light entrance surface of the light guide plate easily comes in contact with the LED. This may damage the LEDs. The gap allows thermal expansion of the light guide plate caused by heat generated at the lighting of the LEDs. The gap also prevents the contact between the LED and the light guide plate.

However, if the gap is provided between the light emitting surface of the LED and the light entrance surface of the light guide plate, the rays of light emitted from the LED mostly reflect off the light entrance surface. Therefore, the light entrance efficiency of the rays of light into the light guide plate is likely to be lowered. This lowers the amount of light exiting from the light output surface of the light guide plate and also lowers brightness.

### DISCLOSURE OF THE PRESENT INVENTION

The present invention was made in view of the foregoing circumstances. An object of the present invention is to achieve improved brightness.

### Means for Solving the Problem

To solve the above problem, a lighting device of the present invention includes at least one light source including a light emitting surface, and a light guide member. The light guide member includes a light entrance surface disposed so as to face the light emitting surface and through which light from the light emitting surface enters and a light exit surface through which the light exits. The light emitting surface and the light entrance surface are formed to be curved and the light entrance surface is processed with an optical process.

The light emitting from the light emitting surface enters the light entrance surface of the light guide member. Because the light emitting surface and the light entrance surface are formed in curved surfaces, the light emitting from the light source efficiently enters the light guide member. Further, since the optical process is performed on the light entrance surface, the conditions of light entering the light entrance surface or the conditions of light reflecting off the light entrance surface are controlled according to the conditions of the optical process. This improves the light entrance efficiency. The “optical process” is performed on the light entrance surface to change the conditions of light entering the light entrance surface or the conditions of light reflecting off the light entrance surface from the conditions thereof in the case the “optical process” is not performed thereon.

### BRIEF DESCRIPTION OF THE DRAWINGS

FIG. 1 is an exploded perspective view illustrating a general construction of a television receiver according to a first embodiment;

FIG. 2 is an exploded perspective view illustrating a general construction of a liquid crystal panel and a backlight unit;

FIG. 3 is a plan view of the backlight unit;

FIG. 4 is a cross-sectional view of a liquid crystal display device along the long-side direction thereof;

FIG. 5 is a magnified cross-sectional view illustrating an end portion of the liquid crystal display in FIG. 4;

FIG. 6 is a magnified cross-sectional view of a light guide plate illustrated in FIG. 5;

FIG. 7 is a magnified cross-sectional view of a lower end portion of the liquid crystal display device in FIG. 3 along the short side direction thereof;

FIG. 8 is a magnified cross-sectional view of an upper end portion of the liquid crystal display device in FIG. 3 along the short side direction thereof;

FIG. 9 is a magnified cross-sectional view of a middle portion of the liquid crystal display device in FIG. 3 along the short side direction thereof;

FIG. 10 is a magnified cross-sectional view of a light guide plate illustrated in FIG. 9;

FIG. 11 is a magnified cross-sectional view of a surrounding part of the light guide plate close to the LED in FIG. 10;

FIG. 12 is a plan view illustrating an arrangement of light guide plates;

FIG. 13 is a plan view of the light guide plate;

FIG. 14 is a bottom view of the light guide plate;

FIG. 15 is a magnified plan view of a surrounding part of the light guide plate close to the LED in FIG. 13;

FIG. 16 is a plan view of a light guide plate according to a second embodiment;

FIG. 17 is a magnified cross-sectional view of a part of the light guide plate close to the LED;

FIG. 18 is a magnified plan view of a part of the light guide plate close to the LED;

FIG. 19 is a magnified cross-sectional view of a part of a light guide plate close to an LED according to a third embodiment;

FIG. 20 is a magnified plan view of a part of the light guide plate close to the LED;

FIG. 21 is a magnified cross-sectional view of a part of a light guide plate close to an LED according to a fourth embodiment;

FIG. 22 is a magnified plan view of a part of the light guide plate close to the LED;

FIG. 23 is a magnified cross-sectional view of a part of a light guide close to an LED according to a fifth embodiment;

FIG. 24 is a magnified plan view of a part of the light guide plate close to the LED; and

FIG. 25 is a magnified cross-sectional view of a light guide plate of a liquid crystal display device of a sixth embodiment.

### BEST MODE FOR CARRYING OUT THE INVENTION

### First Embodiment

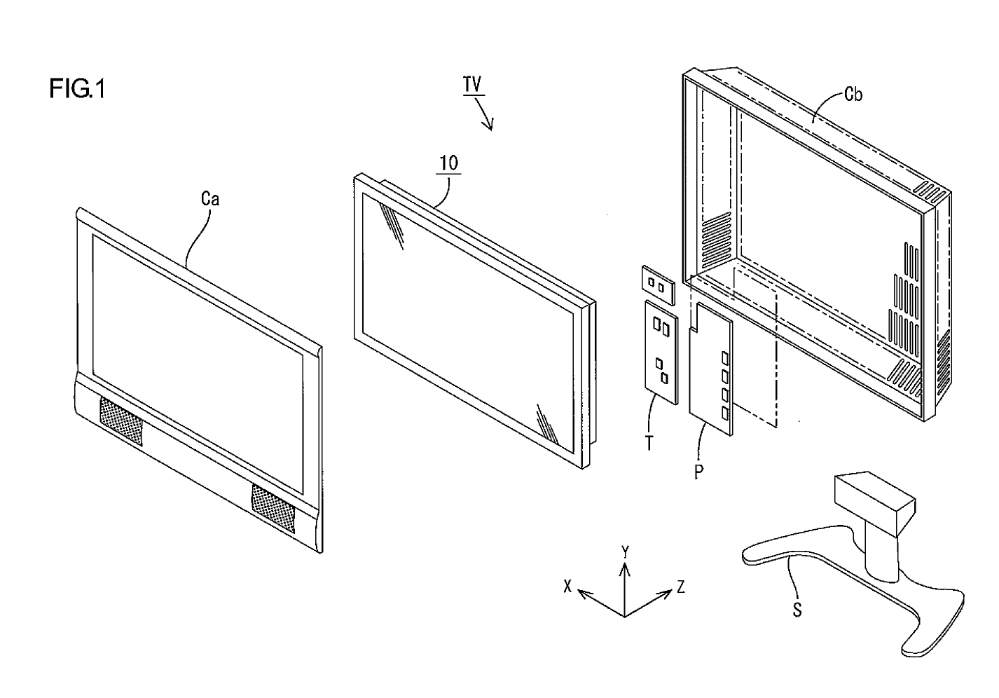

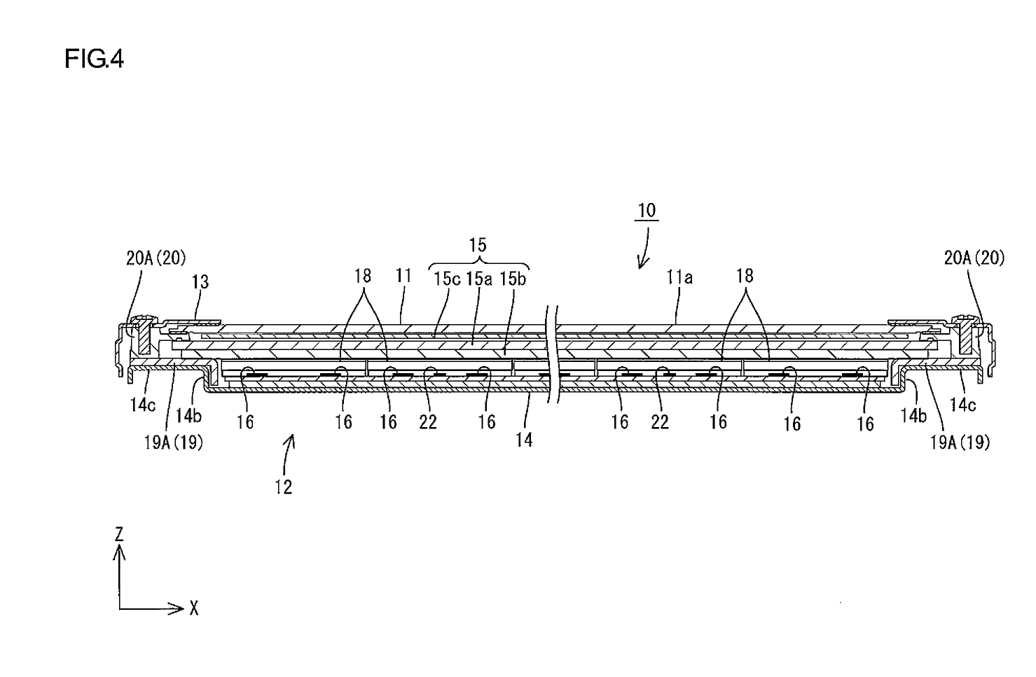

A first embodiment of the present invention will be explained with reference to FIGS. 1 to 15. In this embodiment, a liquid crystal display device 10 will be explained. X-axes, Y-axes and Z-axes in the figures correspond each other so as to indicate the respective directions. In FIGS. 4 to 11, an upper side corresponds to a front-surface side and a lower side corresponds to a rear-surface side.

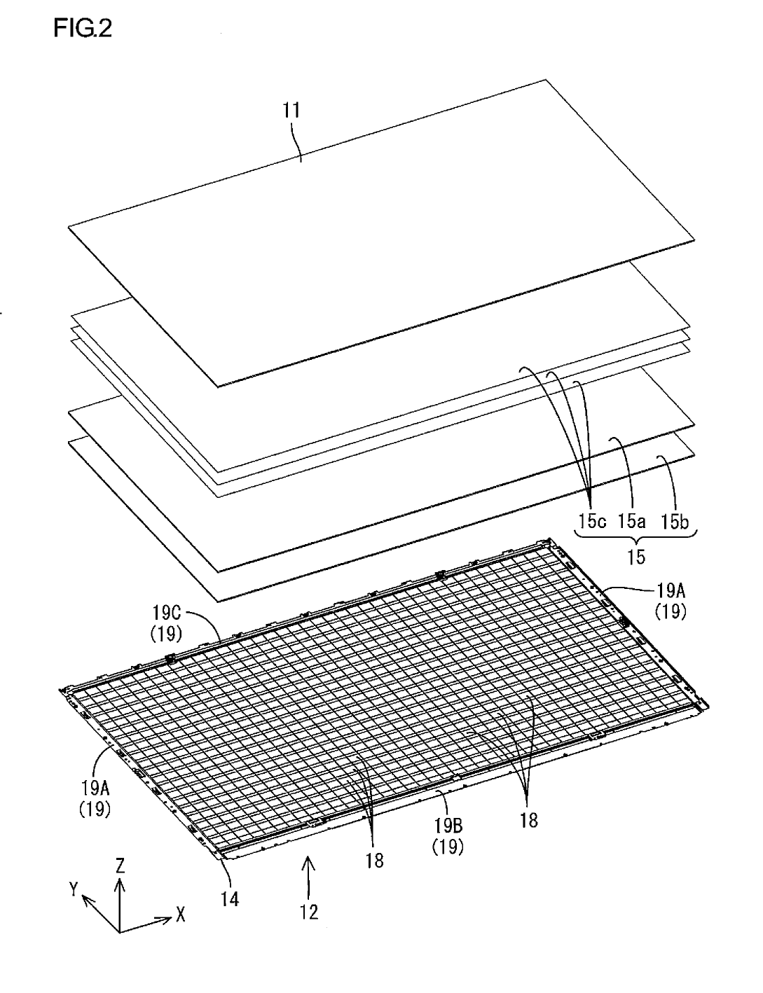

As illustrated in FIG. 1, a television receiver TV of the present embodiment includes the liquid crystal display device 10 (a display device), front and rear cabinets Ca and Cb, a power source P, and a tuner T. The cabinets Ca and Cb sandwich the liquid crystal display device 10 therebetween from the front and the rear. The liquid crystal display device 10 is housed in the cabinets Ca and Cb. The liquid crystal display device 10 is held by a stand S in a vertical position in which a display surface 11a is set along a substantially vertical direction (the Y-axis direction). The liquid crystal display device 10 has a landscape rectangular overall shape. As illustrated in FIG. 2, the liquid crystal display device 10 includes a liquid crystal panel 11, which a display panel, and a backlight unit 12 (a lighting device), which is an external light source. The liquid crystal panel 11 and the backlight unit 12 are held together by a frame-shaped bezel 13.

“The display surface 11a is set along the vertical direction” is not limited to a condition that the display surface 11a is set parallel to the vertical direction. The display surface 11a may be set along a direction closer to the vertical direction than the horizontal direction. For example, the display surface 11a may be 0° to 45° slanted to the vertical direction, preferably 0° to 30° slanted.

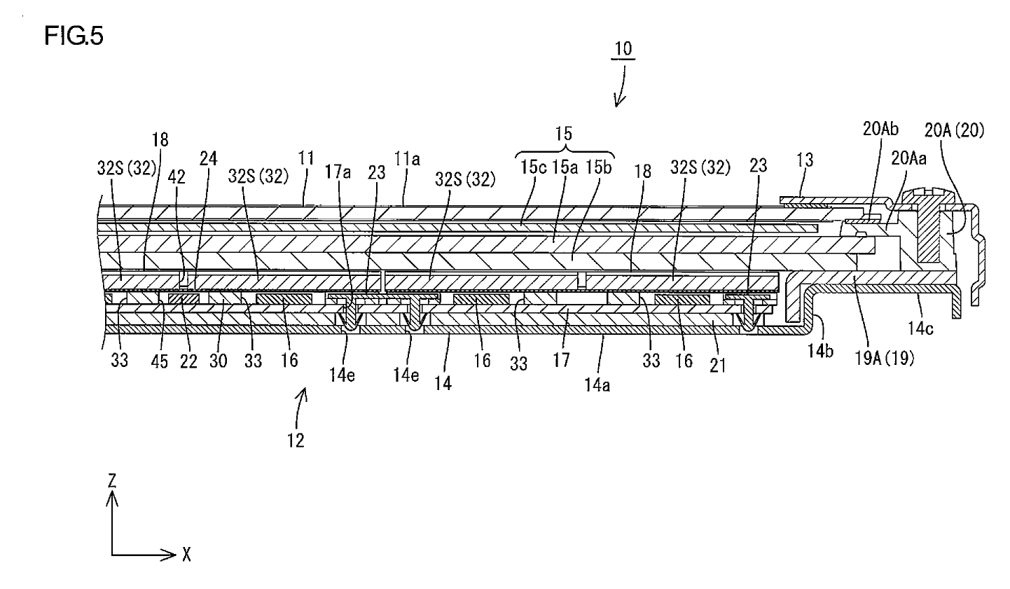

Next, the liquid crystal panel 11 and the backlight unit 12 included in the liquid crystal display device 10 will be explained. The liquid crystal panel (a display panel) 11 has a rectangular plan view and includes a pair of transparent glass substrates bonded together with a predetermined gap therebetween and liquid crystals sealed between the substrates. On one of the glass substrates, switching components (e.g., TFTs), pixel electrodes and an alignment film are arranged. The switching components are connected to gate lines and the source lines that are perpendicular to each other. The pixel electrodes are connected to the switching components. On the other glass substrate, color filters including R (red) G (green) B (blue) color sections in predetermined arrangement, a counter electrode and an alignment film are arranged. Polarizing plates are arranged on outer surfaces of the glass substrates, respectively (refer to FIG. 5).

Next, the backlight unit 12 will be explained in detail. As illustrated in FIG. 4, the backlight unit 12 includes a chassis 14, an optical member 15, LEDs 16 (light emitting diodes), LED boards 17 and light guide plates 18. The chassis 14 has a box-like overall shape and an opening on the front-surface side (on the liquid crystal panel 11 side, on the light output side). The optical member 15 is arranged so as to cover the opening of the chassis 14. The LEDs 16 are light sources arranged inside the chassis 14. The LEDs 16 are mounted on the LED boards 17. Light emitted from the LEDs 16 is directed to the optical member 15 by the light guide plates 18. The backlight unit 12 further includes a receiving member 19, a holding member 20 and heat sinks 21. The receiving member 19 receives diffusers 15a and 15b included in the optical member 15 from the rear-surface side. The holding member 20 holds the diffusers 15a and 15b from the front-surface side. The heat sinks 21 are provided for dissipation of heat generated during lighting of the LEDs 16.

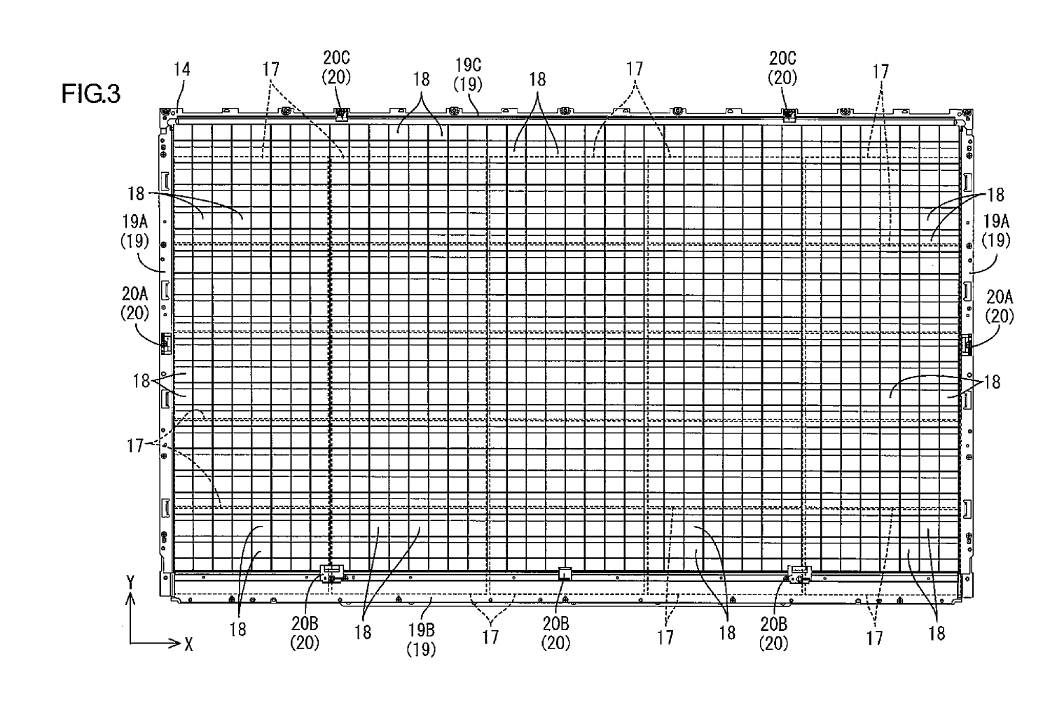

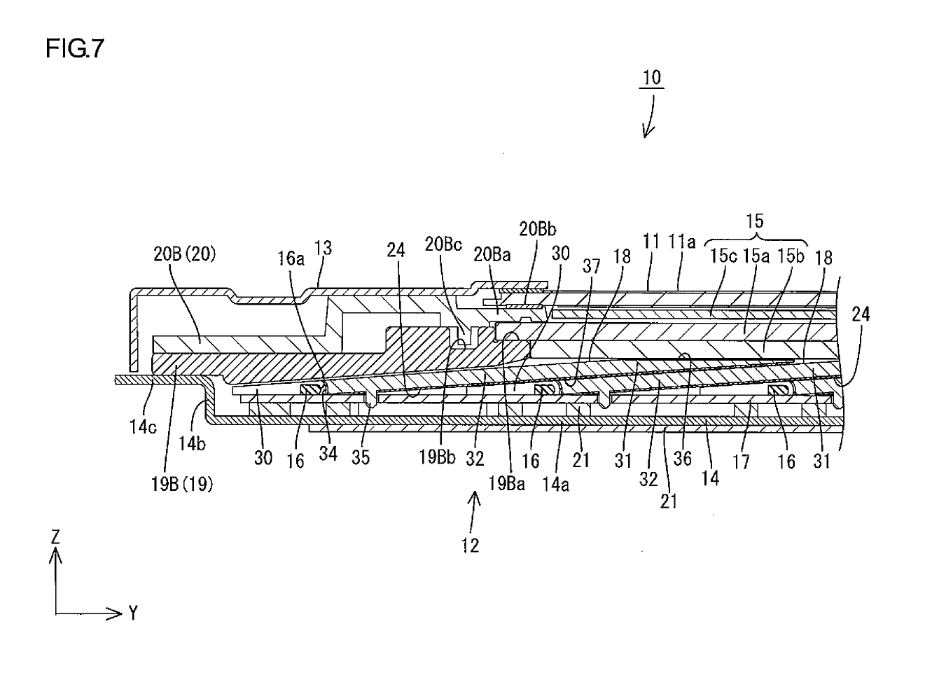

The backlight unit 12 is an edge-light type lighting unit (side-light type) in which the LEDs 16 are provided on one end of the light guide plate 18. In the backlight unit 12, the light guide plate 18 and the LEDs 16 arranged in series form a unit light emitter. A number of the unit light emitters (twenty of them in FIG. 3) are arranged in series along an arrangement direction (an Y-axis direction) in which such the LEDs 16 and the light guide plates 18 are arranged in series, that is in a tandem arrangement (see FIGS. 7 to 9). Furthermore, the backlight unit 12 includes a number of the unit light emitters (forty of them in FIG. 3) arranged parallel to each other in a direction substantially perpendicular to the tandem-arrangement direction (the Y-axis direction) and along the display surface 11a (the X-axis direction). Namely, a number of the unit light emitters are arranged on a plane along the display surface 11a (the X-Y plane), that is, two-dimensionally arranged parallel to each other (see FIG. 3).

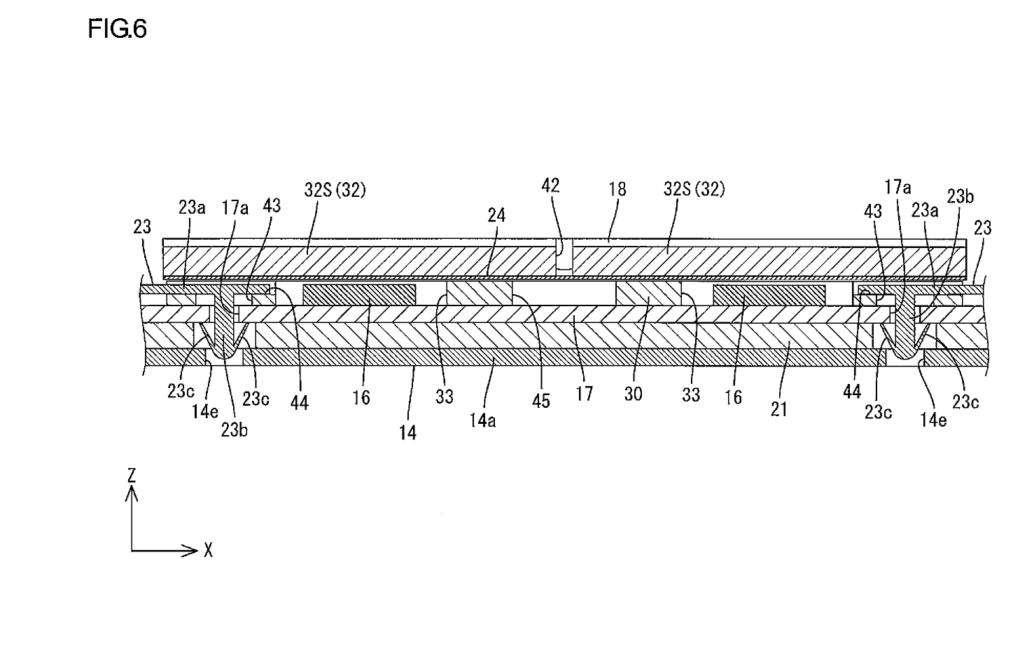

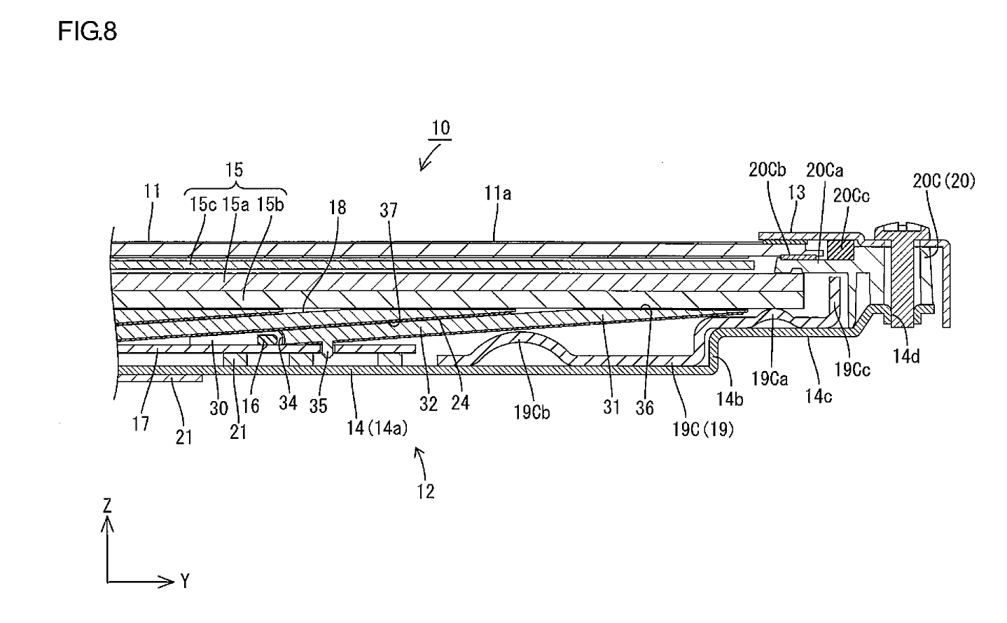

Next, components of the backlight unit 12 will be explained in detail. The chassis 14 is made of metal and has a shallow-box-like overall shape (or a shallow-bowl-like overall shape) with the opening on the front-surface side as illustrated in FIG. 4. The chassis 14 includes a bottom plate 14a, side plates 14b and support plates 14c. The bottom plate 14a has a rectangular shape similar to the liquid crystal panel 11. The side plates 14b rise from the respective edges of the bottom plate 14a. The support plates 14c project outward from the respective end edges of the side plates 14b. The long-side direction and the short-side direction of the chassis 14 correspond the horizontal direction (the X-axis direction) and the vertical direction (the Y-axis direction), respectively. The support plates 14c of the chassis 14 are configured such that the receiving member 19 and the holding member 20 are placed thereon, respectively, from the front-surface side. Each support plate 14c has mounting holes 14d that are through holes for holding the bezel 13, the receiving member 19 and the holding member 20 together with screws and formed at predetermined positions and one of the mounting holes 14d is illustrated in FIG. 8. An outer edge portion of each support plate 14c on the long side is folded so as to be parallel to the corresponding side plate 14b (see FIG. 4). The bottom plate 14a has insertion holes 14e that are through holes for inserting clips 23 therein (see FIGS. 5 and 6). The light guide plates 18 are mounted to the chassis with the clips 23. The bottom plate 14a also has mounting holes (not shown). The mounting holes are through holes for mounting the LED boards 17 with screws and formed at predetermined positions.

As illustrated in FIG. 4, the optical member 15 is arranged between the liquid crystal panel 11 and the light guide plates 18. It includes the diffusers 15a and 15b arranged on the light guide plate 18 side, and an optical sheet 15c arranged on the liquid crystal panel 11 side. Each of the diffusers 15a and 15b includes a transparent resin base material having a predetermined thickness and a large number of diffusing particles scattered in the base material. The diffusers 15a and 15b have functions of diffusing light that passes therethrough. The diffusers 15a and 15b having the same thickness are placed on top of each other. The optical sheet 15c is a thin sheet having a smaller thickness than that of the diffusers 15a and 15b. The optical sheet 15c includes three sheets placed on top of each other, more specifically, a diffuser sheet, a lens sheet and a reflection-type polarizing sheet arranged in this order from the diffuser 15a (15b) side (i.e., from the rear-surface side).

The receiving member 19 is arranged on outer edge portions of the chassis 14 and configured to support almost entire outer edge portions of the diffuser plates 15a and 15b. As illustrated in FIG. 3, the receiving member 19 includes a pair of short-side receiving parts 19A and two different long-side receiving parts 19B and 19C. The short-side receiving parts 19A are arranged so as to extend along the respective short sides of the chassis 14. The long-side receiving parts 19B and 19C are arranged so as to extend along the respective long sides of the chassis 14. The parts of the receiving member 19 are configured differently according to mounting locations. The symbols 19A to 19C are used for referring to the parts of the receiving member 19 independently. To refer to the receiving member 19 as a whole, the numeral 19 without the letters is used.

As illustrated in FIGS. 4 and 5, the short-side receiving parts 19A have substantially same configurations. Each of them has a substantially L-shape cross section so as to extend along a surface of the support plate 14c and an inner surface of the side plate 14b. A part of each short-side receiving part 19A parallel to the support plate 14c receives the diffuser 15b in an inner area and a short-side holding part 20A in an outer area. The short-side receiving parts 19A cover substantially entire lengths of the support plates 14c and the side plates 14b on the short sides.

The long-side receiving parts 19B and 19C are configured differently. Specifically, the first long-side receiving part 19B is arranged on the lower side in the vertical direction of the chassis 14 (the lower side in FIG. 3). As illustrated in FIG. 7, it is arranged so as to extend along the inner surface of the support plate 14c and a surface of the light guide plate 18 located on the front side (a surface opposite from the LED board 17 side). The light guide plate 18 is located adjacent to the support plate 14c. The first long-side receiving part 19B has a function of pressing the adjacent light guide plate 18 from the front-surface side. The first long-side receiving part 19B receives the diffuser 15a that is located on the front-surface side in the inner edge area, and a long-side holding part 20B in the outer edge area. The inner edge area of the first long-side receiving part 19B has a stepped portion 19Ba formed so as to correspond to the shape of the outer edge area of the diffuser 15a that is located on the front-surface side. Adjacent to the stepped portion 19Ba, recesses 19Bb for receiving protrusions 20Bc of the long-side holding part 20B are formed in the first long-side receiving part 19B on the outer side with respect to the stepped portions 19Ba. The first long-side receiving part 19B coves substantially entire lengths of the support plate 14c on the long side and non-luminous portions of the adjacent light guide plates 18 (a board mounting portion 30 and a light guide portion 32). The width of the first long-side receiving part 19B is larger than those of the other receiving parts 19A and 19C by an area that covers the non-luminous portion of the light guide plate 18.

The second long-side receiving part 19C is arranged on the upper side of the chassis 14 (the upper side in FIG. 3). As illustrated in FIG. 8, the second long-side receiving part 19C has a crank-like cross section. It is arranged along the inner surfaces of the support plate 14c, the side plate 14b and the bottom plate 14a. A diffuser support protrusion 19Ca is formed in an area of the second long-side receiving part 19C parallel to the support plate 14c so as to protrude on the front-surface side. The diffuser support protrusion 19Ca has an arch-shaped cross section. It is brought into contact with the diffuser 15b on the rear-surface side from the rear-surface side. Alight guide plate support protrusion 19Cb is formed in an area of the second long-side receiving part 19C parallel to the bottom plate 14a so as to protrude on the front-surface side. The light guide plate support protrusion 19Cb has an arch-shaped cross section. It is brought into contact with the adjacent light guide plate 18 from the rear-surface side. The second long-side receiving part 19C has functions of receiving the diffusers 15a and 15b (i.e., support functions) and light guide plate 18 (i.e., support functions). An area of the second long-side receiving part 19C parallel to the support plate 14c and inside with respect to the diffuser support protrusion 19Ca is brought into contact with the end portion of the light guide plate 18 from the rear-surface side. The light guide plate 18 is supported at two points: at the end portion with the support protrusion 19Ca and at the base portion with the light guide support protrusion 19Cb. The second long-side receiving part 19C covers substantially entire areas of the support plate 14c and the side plate 14b on the long side. A projecting portion 19Cc rises from the outer edge of the second long-side receiving part 19C so as to face the end surfaces of the diffusers 15a and 15b.

As illustrated in FIG. 3, the holding member 20 is arranged on outer edge areas of the chassis 14. A width of the holding member 20 is smaller than a dimension of the corresponding short sides of the chassis 14 and the diffusers 15a and 15b. Therefore, the holding member 20 presses parts of the outer edge portion of the diffusers 15a. The holding member 20 includes short-side holding parts 20A arranged on the respective short-edge area of the chassis 14 and a plurality of long-side holding parts 20B and 20C are arranged on each long-edge area. The parts of the holding member 20 are configured differently according to mounting locations. The symbols 20A to 20C are used for referring to the parts of the holding member 20 independently. To refer to the holding member 20 as a whole, the numeral 20 without the letters is used.

The short-side holding parts 20A are arranged around central portions of the respective short-edge areas of the chassis 14. They are placed on the outer-edge portions of the short-side receiving parts 19A and fixed with screws. As illustrated in FIGS. 4 and 5, each short-side holding part 20A has a holding tab 20Aa that projects inward from a body that is screwed. The diffuser 15a is pressed by edge areas of the holding tabs 20Aa from the front-surface side. The liquid crystal panel 11 is placed on the holding tabs 20Aa from the front-surface side and held between the bezel 13 and the holding tabs 20Aa. Cushion materials 20Ab for the liquid crystal panel 11 are arranged on surfaces of the holding tabs 20Aa.

The long-side holding parts 20B and 20C are configured differently. The first long-side holding parts 20B is arranged on the lower side of the chassis 14 in the vertical direction (the lower side in FIG. 3). As illustrated in FIG. 3, three long-side holding parts 20B are arranged at substantially equal intervals. One of them is arranged around the middle of the long side area of the chassis 14 on the lower side in FIG. 3 and the other two are arranged on either side of the one arranged in the middle. They are placed on the outer edge area of the first long-side receiving part 19B and screwed. As illustrated in FIG. 7, each first long-side holding part 20B has a holding tab 20Ba on the inner side similar to the short-side holding parts 20A. A rear surface of the holding tab 20Ba presses the diffuser 15a. Front-side surfaces receive the liquid crystal display panel 11 via cushion materials 20Bb. The first long-side holding parts 20B have widths larger than those of the other holding parts 20A and 20C so as to correspond to the first long-side receiving parts 19B. Projections 20Bc for positioning the first long-side holding parts 20B to the first long-side receiving parts 19B are formed on the surfaces of the first long-side holding parts 20B on the rear-surface side.

The second long-side holding parts 20C are arranged on the upper side of the chassis 14 in the vertical direction (the upper side in FIG. 3). As illustrated in FIG. 3, two second long-side holding parts 20C are eccentrically arranged in a long-edge area of the chassis 14 on the upper side in FIG. 3. They are directly placed on the support plate 14c of the chassis 14 and screwed. As illustrated in FIG. 8, each second long-side holding part 20C has a holding tab 20Ca on the inner side, similar to the short-side holding parts 20A and the first long-side holing parts 20B. Rear surfaces of the holding tabs 20Ca press the diffuser 15a and the front-side surfaces receive the liquid crystal panel 11 via cushion materials 20Cb. Other cushion materials 20Cc are provided between the holding tabs 20Ca of the second long-side holding parts 20C and the bezel 13.

The heat sinks 21 are made of synthetic resin or metal having high thermal conductivity and formed in a sheet-like shape. As illustrated in FIGS. 5 and 7, the heat sinks 21 are arranged inside and outside the chassis 14, respectively. The heat sink 21 inside the chassis 14 is placed between the bottom plate 14a of the chassis 14 and the LED boards 17. It has cutouts for the components in some areas. The heat sink 21 outside the chassis 14 is arranged on the rear surface of the bottom plate 14a of the chassis 14.

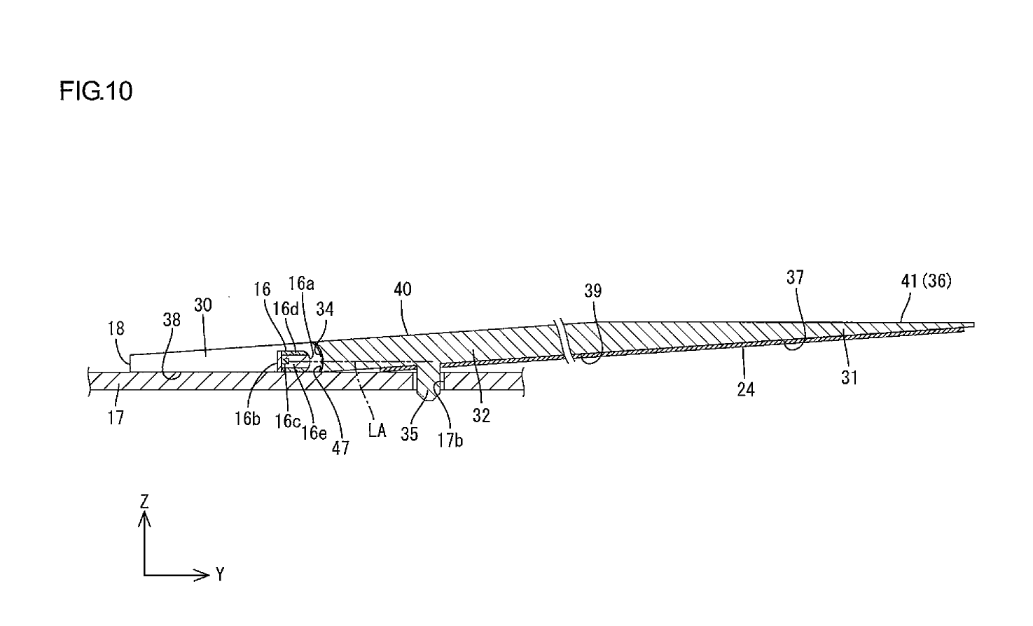

As illustrated in FIG. 10, the LEDs 16 are surface-mounted to the LED boards 17, that is, the LEDs 16 are surface-mount LEDs. Each LED 16 has a block-like overall shape that is long in the horizontal direction. The LEDs 16 are side emitting LEDs. Aside surface of each LED 16 that stands upright from a mounting surface is a light emitting surface 16a. The mounting surface is placed against the LED board 17 (i.e., the bottom surface that is in contact with the LED board 17). A light axis LA of light emitted from the LED 16 is substantially parallel to the display surface 11a of the liquid crystal display panel 11 (the light exit surface 36 of the light guide plate 18) (see FIGS. 7 and 10). Specifically, the light axis LA of the light emitted from the LED 16 matches the short-side direction (the Y-axis direction) of the chassis 14, that is, the vertical direction. The light travels toward the upper side in the vertical direction (a travel direction of the outgoing light from the light emitting surface 16a) (see FIGS. 3 and 7). The light emitted from the LED 16 three-dimensionally radiates around the light axis LA in a specified angle range. The directivity thereof is higher than cold cathode tubes. Namely, angle distributions of the LED 16 shows a tendency that the emission intensity of the LED 16 is significantly high along the light axis LA and sharply decreases as the angle to the light axis LA increases. The longitudinal direction of the LED 16 matches the long-side direction of the chassis 14 (the X-axis direction).

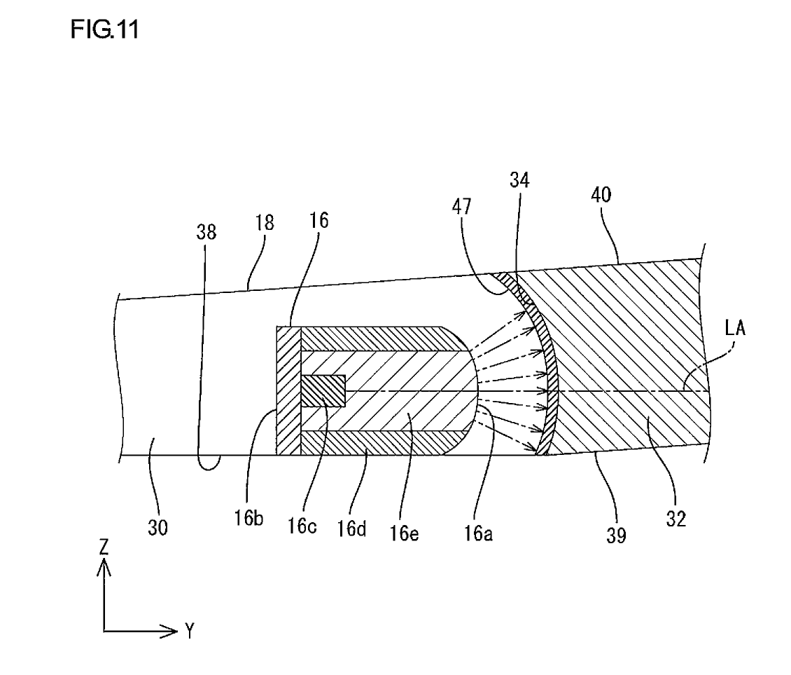

As illustrated in FIG. 11, the LED 16 includes a plurality of LED chips 16c mounted on a board 16b that is arranged on an opposite side from the light emitting surface 16a (the rear-surface side). The LED chips 16c are light emitting components. The LED 16 is housed in the housing 16d and an inner space of the housing 16d is closed with a resin member 16e. The LED 16 includes three different kinds of the LED chips 16c with different main emission wavelengths. Specifically, each LED chip 16c emits a single color of light of red (R), green (G) or blue (B). The LED chips 16c are arranged parallel to each other along the longitudinal direction of the LED 16. The housing 16d is formed in a drum-like shape that is long in the horizontal direction and in white that provides high light reflectivity. The rear surface of the board 16b is soldered to a land on the LED board 17.

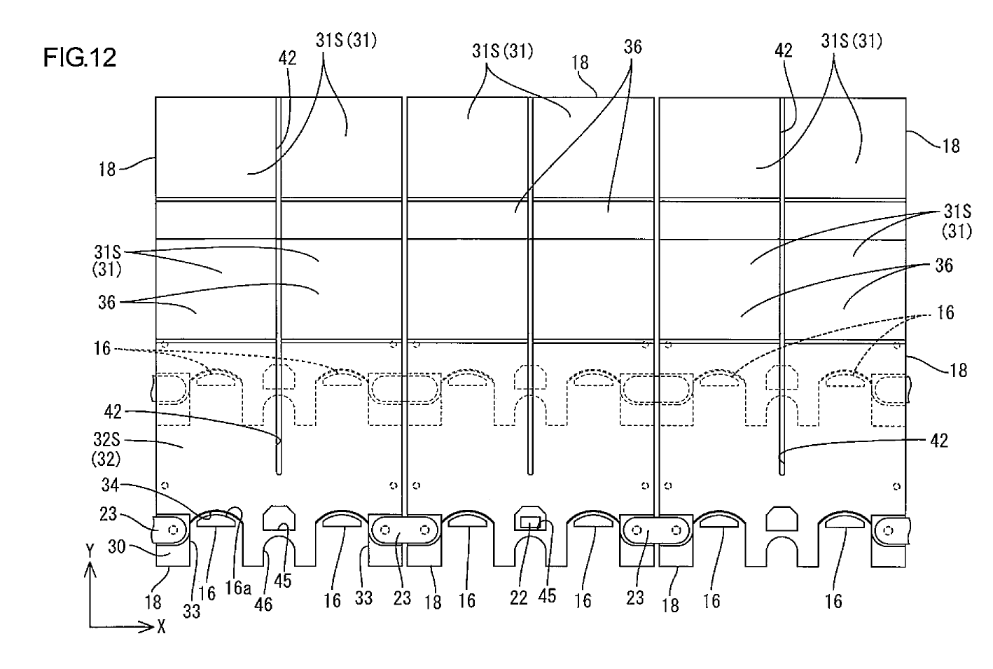

Each LED board 17 is made of synthetic resin and the surfaces thereof (including a surface facing the light guide plate 18) are in white that provides high light reflectivity. As illustrated in FIG. 3, the LED board 17 is formed in a plate-like shape having a rectangular plan view. The LED board 17 has along dimension smaller than the short dimension of the bottom plate 14a and thus it can partially cover the bottom plate 14a of the chassis 14. The LED boards 17 are in a plane arrangement in a grid pattern on the surface of the bottom plate 14a of the chassis 14. In FIG. 3, five along the long-side direction of the chassis 14 by five along the short-side direction and a total of 25 LED boards 17 are arranged parallel to each other. Wiring patterns that are metal films are formed on each LED board 17 and the LEDs 16 are mounted in predetermined locations on the LED board 17. The LED boards 17 are connected to an external control board (not shown). The control board is configured to feed currents for turning on the LEDs 16 and to perform driving control of the LEDs 16. A number of LEDs 16 are arranged in a planar grid pattern on each LED board 17. The arrangement pitch of the LEDs 16 corresponds the arrangement pitch of the light guide plates 18, which will be explained later. Specifically, eight along the long-side direction of the LED board 17 by four along the short-side direction thereof and a total of 32 LEDs 16 are arranged parallel to each other on the LED board 17. Photo sensors 22 are also mounted on the respective LED boards 17. Light emitting conditions of the LEDs 16 are determined by the photo sensors 22 and thus feedback control can be performed on the LEDs 16 (see FIGS. 4 and 12). Each LED board 17 has mounting holes 17a for receiving the clips 23 for mounting the light guide plates 18 (see FIG. 6). It also has positioning holes 17b for positioning the light guide plates 18 (see FIG. 10). The holes are formed in locations corresponding to mounting locations of the light guide plates 18.

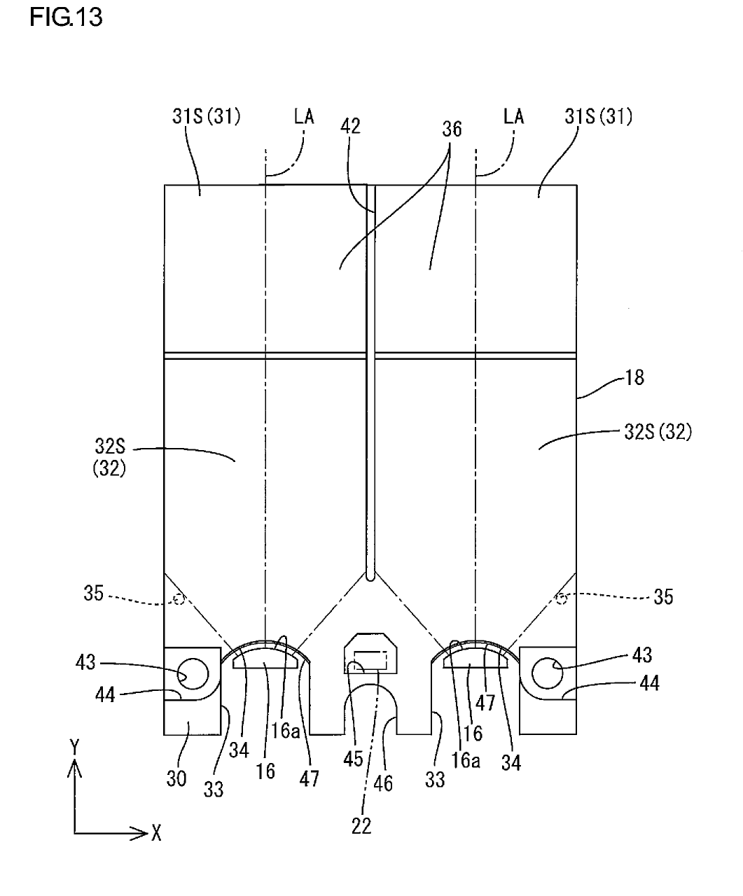

Each light guide plate 18 is made of substantially transparent (i.e., having high light transmission capability) synthetic resin (e.g. polycarbonate), a reflective index of which is significantly higher than that of air. As illustrated in FIGS. 7 to 9, the light guide plate 18 draws the light emitted from the LED 16 in the vertical direction (the Y-axis direction), transmits the light therethrough and directs it toward the optical member 15 (in the Z direction). As illustrated in FIG. 13, the light guide plate 18 has a plate-like shape having a rectangular overall plan view. The long-side direction of the light guide plate 18 is parallel to the light axis LA of the LED 16 (the light emitting direction) and the short-side direction of the chassis 14 (the Y-axis direction or the vertical direction). The short-side direction is parallel to the long-side direction of the chassis 14 (the X-axis direction or the horizontal direction). Next, a cross-sectional structure of the light guide plate 18 along the long-side direction will be explained in detail.

As illustrated in FIGS. 7 to 9, the light guide plate 18 has a board mounting portion 30 that is located at one of end portions of the long dimension (on the LED 16 side) and attached to the LED board 17. The other end portion of the long dimension is configured as a light exit portion 31 from which light exits toward the diffusers 15a and 15b. The middle portion between the board mounting portion 30 and the light exit portion 31 is configured as a light guide portion 32. The light guide portion 32 is configured to direct the light to the light exit portion 31 without losing most of the light. Namely, the board mounting portion 30 (LED 16), the light guide portion 32 and the light exit portion 31 are arranged in this order from the LED 16 side along the long-side direction of the light guide plate 18, that is, along the light axis LA (the light emitting direction) of the LED 16. The board mounting portion 30 and the light guide portion 32 are non-luminous portions. The light exit portion 31 is a luminous portion. In the following description, a point ahead in a direction from the board mounting portion 30 toward the light exit portion 31 (the light emitting direction of the LED 16 or the direction toward right in FIGS. 7 to 9) is referred to as the front. A point behind in a direction from the light exit portion 31 toward the board mounting portion 30 (the direction toward left in FIGS. 7 to 9) is referred to as the rear.

At the front of the board mounting portion 30, an LED holding space 33 is formed so as to run through in the Z-axis direction and open toward the rear side (FIG. 13). A surface of one of inner walls of the LED holding space 33, which faces the light emitting surface 16a of the LEC 16 (i.e., the front surface), is an entrance surface 34 through which light from the LED 16 enters. The entrance surface 34 is provided at the border between the board mounting portion 30 and the light guide portion 32. About entire peripheries of the light guide portion 32 are flat and smooth surfaces. Scattered reflections do not occur at interfaces (between the surfaces and external air layers). Incident angles of light that strikes the interfaces are larger than a critical angle and thus the light is totally reflected at multiple times while traveling through the light guide portion 32 and guided to the light exit portion 31. Therefore, the light is less likely to leak from the light guide portion 32 and reach other light guide plates 18. The LED chips 16c of the LED 16 emits rays of light in respective RGB colors. Three different colors of the rays are mixed as the rays of light travel through the light guide portion 32 and turn into white. The white light is guided to the light exit portion 31. The positioning protrusion 35 protrudes toward the rear-surface side. It is located in an area of the light guide portion 32 close to the board mounting portion 30 (close to a rear end area). The light guide plate 18 is positioned with respect to the LED board 17 in the X-axis direction and the Y-axis direction when the protrusion 35 is inserted in the positioning hole 17b of the LED board 17.

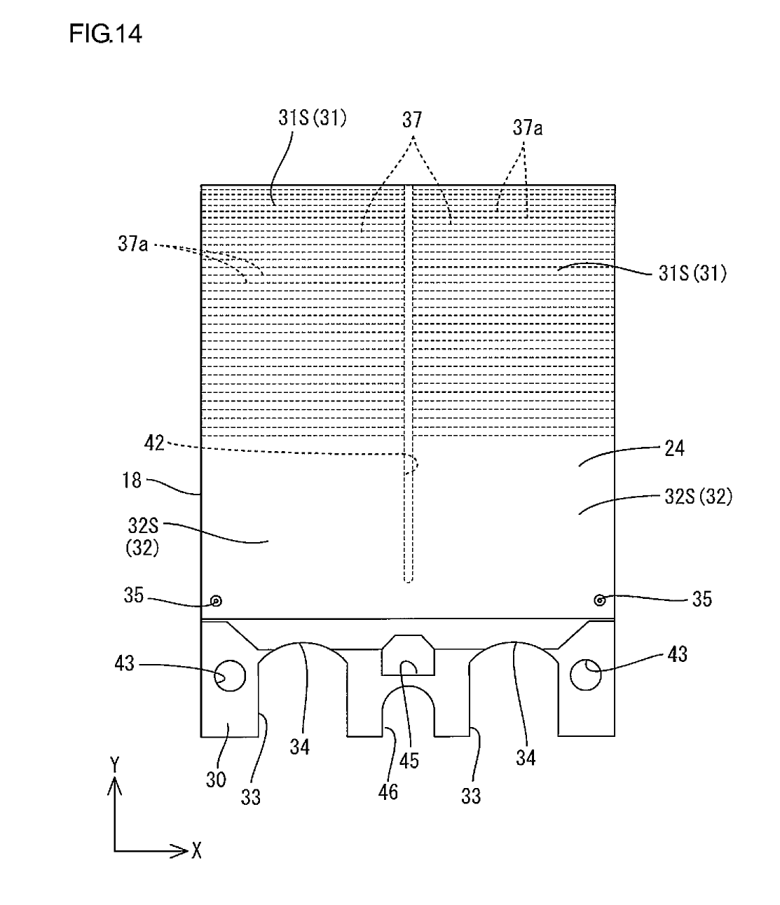

A surface of the light exit portion 31 which faces toward the front-surface side is about an entire area of the surface opposite the diffuser 15b is a light exit surface 36. The light exit surface 36 is a substantially flat and smooth surface. It is substantially parallel to the plate surfaces of the diffusers 15a and 15b (or the display surface 11a of the liquid crystal display panel 11) and perpendicular to the light entrance surface 34. The rear surface of the light exit portion 31 (the surface opposite from the light exit surface 36 or the surface facing the LED board 17) is processed so as to form microscopic asperities thereon. The surface with microscopic asperities is a scattering surface 37 that scatters light at the interface. The light that travels through the light guide plate 18 is scattered by the interface of the scattering surface 37. Namely, light rays strike the light exit surface 36 at the incident angles smaller than the critical angle and exit through the light exit surface 36. The scattering surface 37 has a plurality lines of perforations 37a that extend straight along the short-side direction of the light guide plate 18 and parallel to each other. The arrangement pitch (the arrangement interval) of the perforations 37a is larger on the rear-end side of the light exit portion 31 than on the front-end side and gradually decreases (FIG. 14). Namely, the density of the perforations 37a of the scattering surface 37 is low on the rear-end side and that is high on the front side. The closer to the LED 16 the lower the density becomes, and the farther from the LED 16 the higher the density becomes. With this configuration, brightness in the area of the light exit portion 31 closer to the LED 16 is less likely to differ from brightness in the area of the light exit portion 31 father from the LED 16. As a result, the uniform in-plane brightness distribution can be achieved on the light exit surface 36. The scattering surface 37 is provided in the about entire area of the light exit portion 31. The entire area substantially overlaps the light exit surface 36 in the plan view.

A reflection sheet 24 is placed on surfaces of the light exit portion 31 and the light guide portion 32 (including the scattering surface 37) on the rear-surface side. The reflection sheet 24 is configured to reflect light such that the light enters the light guide plate 18. The reflection sheet 24 is made of synthetic resin and the surface thereof is white that provides high light reflectivity. The reflection sheet 24 is disposed so as to cover about entire areas of the light exit portion 31 and the light guide portion 32 in the plan view (see FIG. 14). With the reflection sheet 24, the light that travels through the light guide plate 18 does not leak to the rear-surface side and the light that is scattered at the scattering surface 37 is effectively directed toward the light exit surface 36. The reflection sheet 24 is attached to the light guide plate 18 with adhesives at points in side edge areas that are less likely to interfere with light that travels through the light guide plate 18. The reflection sheet 24 has holes through which the positioning protrusions 35 are passed so as to correspond to the positioning protrusions 35. The side surface and the front surface (distal end surface) of the light exit portion 31 are flat and smooth surfaces like the light guide plate, and therefore the light is less likely to leak.

As illustrated in FIG. 10, the light guide plate 18 has flat surfaces 38 and 41 on the front-surface side (the surface opposite the diffusers 15a and 15b, including the light exit surface 36) and on the rear-surface side (the surface opposite the LED board 17), respectively. The light guide plate 18 also has sloped surfaces 39 and 40 on the front-surface side and on the rear-surface side, respectively. The flat surfaces 38 and 41 are parallel to the X-Y plane (or the display surface 11a). The sloped surfaces 39 and 40 are sloped with respect to the X-Y plane. Specifically, the rear surface of the board mounting portion 30 is a mounting surface that is placed on the LED board 17. To make the mounting condition stable, the flat surface 38 (the surface parallel to the main board surface of the LED board 17) is provided. The rear surfaces of the light guide portion 32 and the light exit portion 31 form a continuous sloped surface 39. The board mounting portion 30 of the light guide plate 18 is in contact with the LED board 17 and fixed. The light guide portion 32 and the light exit portion 31 are separated from the LED board 17, that is, they are not in contact with the LED board 17. The light guide plate 18 is held in a cantilever manner with the board mounting portion 30 on the rear side as an anchoring point (or a supporting point) and a front end as a free end.

The front surfaces of entire parts of the board mounting portion 30 and the light guide portion 32 and a part of the light exit portion 31 close to the light guide portion 32 on the front-surface side form the continuous sloped surface 40. The sloped surface 40 is sloped at about the same angle and parallel with respect to the sloped surface 39 on the rear-surface side. Namely, the thickness of the light guide plate 18 is substantially constant in the entire light guide portion 32 and a part of the light exit portion 31 close to the light guide portion 32 (close to the LED 16). The surface of the light exit portion 31 on the front side (away from the LED 16) on the front-surface side is the flat surface 41. Namely, the light exit surface 36 includes the flat surface 41 and the sloped surface 40. Most part of the light exit surface 36 on the front side is the flat surface 41 and a part thereof on the light guide portion 32 side is the sloped surface 40. The thickness of the board mounting portion 30 decreases toward the rear end (as further away from the light guide portion 32), that is, the board mounting portion 30 has a tapered shape. A part of the light exit portion 31 adjacent to the light guide portion 32 has the sloped surface 40 on the front-surface side and thus the thickness thereof is constant. A part of the light exit portion 31 located more to the front than the above part has the flat surface 41 on the front-surface side. Therefore, the thickness gradually decreases toward the front end (as further away from the light guide portion 32), that is, the light exit portion 31 has a tapered shape. A long dimension (a dimension measuring in the Y-axis direction) of the flat surface 41 on the front-surface side is smaller than that of the flat surface 38 on the rear-surface side. The front-end portion of the light exit portion 31 has a thickness smaller than that of the rear end portion of the board mounting portion 30. The front end surface (distal end surface) of the light exit portion 31 has a surface area smaller than that of the rear end surface of the board mounting portion 30. The entire peripheries of the light guide plate 18 (including the side surfaces and the front end surface) are vertical surfaces that extend substantially vertical along the Z-axis direction.

As illustrated in FIG. 13, the light guide plate 18 having the above-described cross-sectional structure includes a pair of the LED holding spaces 33 for holding the LEDs 16. The light guide plate 18 is configured to receive rays of light from two different LEDs 16 and guide them to the diffusers 15a and 15b in optically independent conditions. How light is guided will be explained along with planar arrangements of parts of the light guide plate 18.

The light guide plate 18 has a symmetric shape with a line that passes through the middle of the short side (in the X-axis direction) as a line of symmetry. The LED holding spaces 33 of the board mounting portion 30 are arranged symmetrically a predetermined distance away from the middle of the short side (in the X-axis direction) of the light guide plate 18. Each LED holding space 33 penetrates through the light guide plate 18 in the Z-axis direction and is open rearward. Namely, each LED holding space 33 has an arched gate shape and has an open end in the plan view. Parts of the surrounding portion of the LED holding space 33 on either side of the LED 16 form a part of the board mounting portion 30 provided parallel to the LED board 17. This stabilizes the mounting of the light guide plate 18 on the LED board 17. Because the LED holding space 33 is formed to be open rearward, the light entrance surface 34 is bare to the external space on the rear side. The LED holding space 33 is slightly larger than the overall size of the LED 16. Namely, the height (the dimension measuring in the Z-axis direction) and the width (the dimension measuring in the X-axis direction) are slightly larger than those of the LED 16. The surface area of the light entrance surface 34 is significantly larger than the light emitting surface 16a. Therefore, the rays of light emitted radially from the LED 16 enter the light guide plate 18 without any loss.

At the middle of the light guide plate 18 in the short-side direction, a slit 42 is formed so as to divide the light guide portion 32 and the light exit portion 31 into right and left. The slit 42 runs through the light guide plate 18 in the thickness direction (the Z-axis direction) and toward the front along the Y-axis direction with a constant width. End surfaces of the light guide plate 18 which face the slit 42 form side edge surfaces of the divided light guide portion 32S and the divided light exit portion 31S. The surfaces are flat and smooth surfaces arranged substantially straight along the Z-axis direction. The rays of light passing through the light guide plate 18 all reflect off an interface between the end surfaces and the air layer of the slit 42. Therefore, the rays of light do not travel or mix together between the divided light guide portions 32S that faces each other via the slit 42 or between the divided light exit portions 31S that faces each other via the slit 42. Namely, the divided light guide portions 32S and the divided light exit portions 31A have optically independent configurations. The rear end of the slit 42 is slightly more to the front than the positioning protrusion 35 and more to the rear than a lighting area of each LED 16 with respect to the X-axis direction (the area within an angular range with the light axis LA of the LED 16 as the center and indicated by alternate long and short dash lines in FIG. 13). With this configuration, the rays of light emitted from the LED 16 do not directly enter the adjacent divided light guide portion 32S that is not a target to be lit. The positioning protrusions 35 are symmetrically located on the outer end areas of the divided light guide portions 32S (the end portions away from the slit 42) more to the rear than the lighting areas of the respective LEDs 16 with respect to the X-axis direction. Therefore, the positioning protrusions 35 are less likely to be obstacles in optical paths. The slit 42 does not run to the board mounting portion 30. Therefore, the divided light guide portions 32 connect to each other and continue into the board mounting portion 30. This provides mechanical stability in mounting conditions. The light guide plates 18 are optically independent from each other. The light guide plate 18 includes two unit light guide plates (corresponding to the divided light guide portion 32S and the divided light exit portion 31S). The unit light guide plates are optically independent from each other and provided each for each LED 16. The unit light guide plates are connected to each other together with the board mounting portion 30. This simplifies mounting of the light guide plate 18 to the LED board 17. The reflection sheet 24 is placed over the slit 42 (see FIG. 14).

Clip insertion holes 43 are formed in the side-end areas of the board mounting portion 30 (in the areas more to the outsides than the LED holding space 33). The clip mounting holes 43 are through holes provided for mounting the light guide plate 18 to the LED board 17. As illustrated in FIG. 6, each clip 23 includes a mounting plate 23a, an insertion post 23b and a pair of stoppers 23c. The mounting plate 23a is parallel to the board mounting portion 30. The insertion post 23b projects from the mounting plate 23a in the thickness direction (the Z-axis direction) of the board mounting portion 30. The stoppers 23c project from an end of the insertion post 23b so as to return toward the mounting plate 23a. The insertion post 23b of the clip 23 is inserted in the clip insertion hole 43 of the board mounting portion 30 and the mounting hole 17a of the LED board 17. The stoppers 23c of the clip 23 are held to the edge portions around the mounting hole 17a. As a result, the light guide plate 18 is mounted and fixed to the LED board 17. As illustrated in FIGS. 5 and 12, one kind of the clips 23 has a single insertion post 23b projecting from the mounting plate 23a and the other kind has two insertion posts 23b projecting from the mounting plate 23a. The first kind of the clips 23 are inserted in the clip insertion holes 43 located in the end areas inside the chassis 14. The other kind of the clips 23 are arranged so as to connect two light guide plates 18 that are parallel to each other and thus the two light guide plates 18 are collectively mountable. As illustrated in FIGS. 6 and 13, clip receiving recesses 44 for receiving the mounting plates 23a of the clips 23 are provided around the clip insertion holes 43. With the clip receiving recesses 44, the mounting plates 23a do not project from the board mounting portions 30 toward the front and thus spaces can be reduced, that is, the thickness of the backlight unit 12 can be reduced.

As illustrated in FIG. 13, each board mounting portion 30 has a photo sensor holding space 45 between the LED holding spaces 33 of the board mounting portion 30. The photo sensor holding space 45 is a through hole for holding the photo sensor 22 mounted on the LED board 17. A predetermined number of the photo sensors 22 are arranged irregularly, that is, between specific LEDs on the LED boards 17. Namely, some photo sensor holding spaces 45 of the light guide plates 18 in the chassis 14 do not hold the photo sensors 22. Each board mounting portion 30 has a cutout 46 between each LED holding space 33 and the photo sensor holding space 45. Each cutout 46 runs completely through the board mounting portion 30 similar to the LED holding space 33 but opens on the rear end. A screw (not shown) for fixing the LED board 17 to the chassis 14 is inserted in the cutout 46. Some of the cutouts 46 are not used for light guide plates 18 in the chassis 14, as some photo sensor holding spaces 45 are not used.

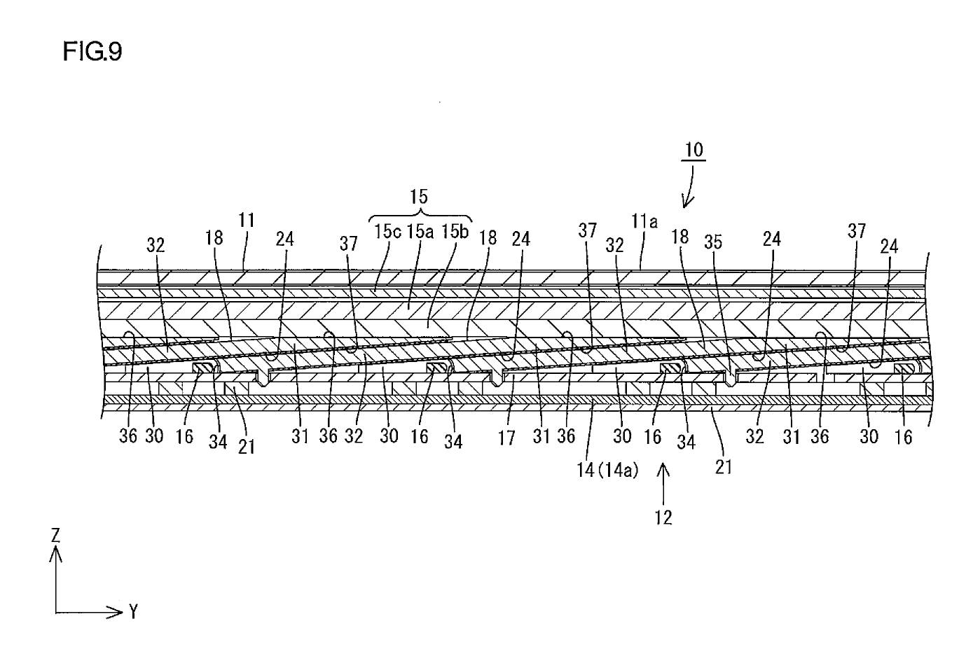

As described above, a large number of the light guide plates 18 are placed in a grid and in a planar arrangement within the area of the bottom plate 14a of the chassis 14. The arrangement of the light guide plates 18 will be explained in detail. First, the arrangement in the tandem-arrangement direction (the Y-axis direction) will be explained. As illustrated in FIG. 9, the light guide plates 18 are mounted such that the light guide portions 32 and the light exit portions 31 are separated from the LED boards 17. The light guide portion 32 and the light exit portion 31 of each light guide plate 18 overlap about entire areas of the board mounting portion 30 and the light guide portion 32 of the adjacently located light guide plate 18 on the front side (the upper side in the vertical direction) from the front-surface side. In the light guide plates 18 arranged parallel to the tandem-arrangement direction, the light guide plate 18 that is arranged on the relatively rear side (the first light guide plate 18A) is arranged on a front-surface side, that is the light output side (on the diffuser 15b side), and the light guide plate 18 that is arranged on the relatively front side (the second light guide plate 18B) is arranged on a rear-surface side, that is the side opposite from the light output side (the LED substrate 17 side). Namely, the board mounting portion 30 and the light guide portion 32 of the light guide plate 18 on the relatively front side overlap the light guide portion 32 and the light exit portion 31 of the light guide plate 18 on the relatively rear side in the plan view. The board mounting portion 30 and the light guide portion 32, which are the non-luminous portion of the light guide plate 18, are covered with the light guide portion 32 and the light exit portion 31 of the adjacent light guide plate 18 that is on the rear side. Namely, the board mounting portion 30 and the light guide portion 32 are not bare on the diffuser 15b side and only the luminous portion, that is, the light exit surface 36 of the light exit portion 31 is bare on the diffuser 15b side. With this configuration, the light exit surfaces 36 of the light guide plates 18 are continuously arranged without gaps in the tandem-arrangement direction. About entire rear surfaces of the light guide portion 32 and the light exit portion 31 are covered with the reflection sheet 24. Therefore, even when light is reflected by the light entrance surface 34 and leak occurs, the leak light does not enter the adjacent light guide plate 18 on the rear side. The light guide portion 32 and the light exit portion 31 of the light guide plate 18 on the rear side (the front-surface side) is mechanically supported by the adjacent overlapping light guide plate 18 on the front side (the rear-surface side) from the rear-surface side. The sloped surface 40 of the light guide plate 18 on the front-surface side and the sloped surface 39 on the rear-surface side have substantially same slope angles and are parallel to each other. Therefore, gaps are not created between the overlapping light guide plates 18 and the light guide plates 18 on the rear-surface side support the light guide plates 18 on the chassis 14 side without rattling. Only front side parts of the light guide portions 32 of the light guide plates 18 on the rear side cover the board mounting portions 30 of the light guide plates 18 on the front side. The rear-side parts face the LED boards 17.

The arrangement in a direction perpendicular to the tandem-arrangement direction (the X-axis direction) is illustrated in FIGS. 5 and 12. The light guide plates 18 do not overlap each other in the plan view. They are arranged parallel to each other with predetermined gaps therebetween. With the gaps, air layers are provided between the light guide plates 18 adjacent to each other in the X-axis direction. Therefore, the rays of light does not travel or mix between the light guide plates 18 adjacent to each other in the X-axis direction and thus the light guide plates 18 are optically independent from each other. The size of the gaps between the light guide plates 18 is equal to or smaller than that of the slit 42.

As illustrated in FIGS. 3 and 12, a large number of the light guide plates 18 are arranged in the planar arrangement inside the chassis 14. The light exit surface of backlight unit 12 is formed with a number of the divided light exit portions 31S. As described above, the divided light guide portions 32s and the divided light exit portions 31S of the light guide plates 18 are optically independent from each other. Turning on and off of the LEDs 16 are controlled independently. The outgoing light (emission or non-emission of light) from the divided light exit portion 31S can be controlled independently. The driving of the backlight unit 12 can be controlled using an area active technology that provides control of outgoing light for each area. This significantly improves contrast that is very important for display performance of the liquid crystal display device 10.

As illustrated in FIG. 13, the LED 16 is arranged in the LED holding space 33 with entire peripheries thereof are separated from the inner walls of the LED holding space 33 (including the light entrance surface 34) by gaps in predetermined sizes. The gaps are provided for compensating for an error related to a mounting position of the light guide plate 18 with respect to the LED board 17. The gaps are required for allowing thermal expansion of the light guide plate 18, which may occur due to heat generated during lighting of the LED 16. By providing the gaps between the LED 16 and the walls of the LED holding space 33, the light guide plate 18 is less likely to touch the LED 16 in the assembling and thermal expansion and thus the LED 16 is protected from being damaged.

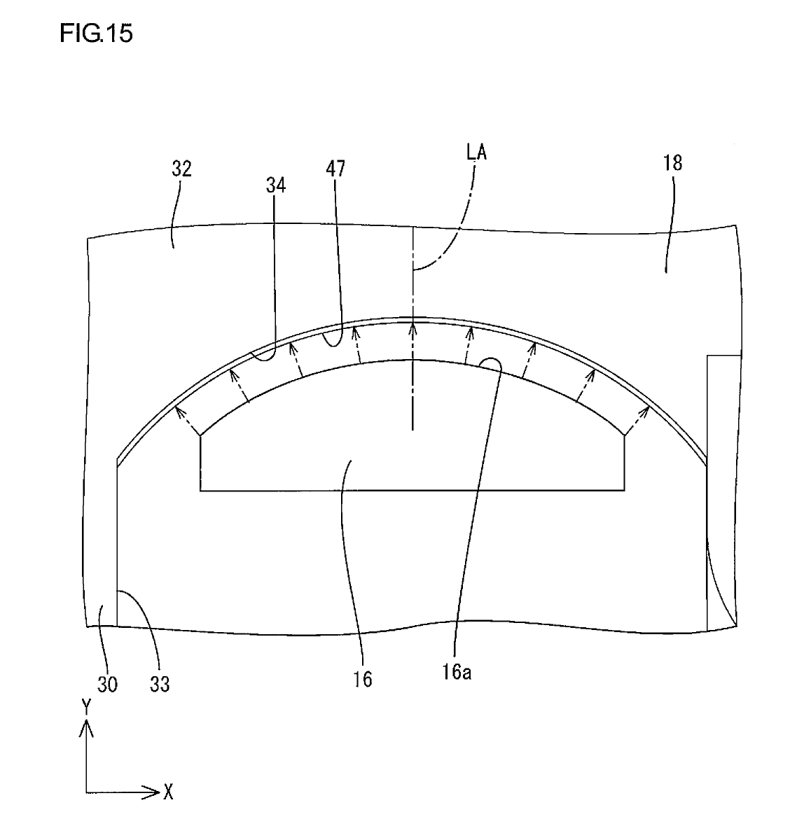

In the present embodiment, the light emitting surface 16a of the LED 16 and the light entrance surface 34 of the light guide plate 18 are formed in a curved shape and the optical process is performed on the light entrance surface 34 to improve the light entrance efficiency. Specifically, as illustrated in FIGS. 11 and 15, the light emitting surface 16a of the LED 16 is formed in a curved convex shape and the light entrance surface 34 is formed in a curved recessed shape. As illustrated in FIG. 11, each of the light emitting surface 16a of the LED 16 and the light entrance surface 34 of the light guide plate 18 has a substantially arc-shaped cross section and they are formed in the arc-shaped cross-sectional shape so as to follow each other with a substantially constant gap therebetween. The cross section is taken along the Y-axis direction and the Z-axis direction, that is, along the arrangement direction in which the light emitting surface 16a and the light entrance surface 34 are arranged and substantially perpendicular to the light exit surface 36. As illustrated in FIG. 15, each of the light emitting surface 16a of the LED 16 and the light entrance surface 34 of the light guide plate 18 has a substantially arc-shaped cross section and they are formed in the arc-shaped cross-sectional shape so as to follow each other with a substantially constant gap therebetween. The cross section is taken along the X-axis direction and the Y-axis direction, that is, along the arrangement direction in which the light emitting surface 16a and the light entrance surface 34 are arranged and substantially perpendicular to the light exit surface 36. Namely, as illustrated in FIGS. 11 and 15, the light emitting surface 16a of the LED 16 and the light entrance surface 34 of the light guide plate 18 form a substantially spherical surface and they are formed to follow each other with a substantially constant gap therebetween. Further, the cross sections of the light emitting surface 16a of the LED 16 and the light entrance surface 34 of the light guide plate 18 are substantially concentric and therefore, the gap between the light emitting surface 16a and the light entrance surface 34 is substantially constant over an entire area. The rays of light emitted from the light emitting surface 16a that is a spherical surface radiate three-dimensionally around the light axis LA. Therefore, the rays of light easily enter the light entrance surface 34 of the light guide plate 18 that is a spherical surface from the normal direction. Therefore, rays of light are less likely to reflect off the light entrance surface 34 and to be directed to outside of the light guide plate 18. The rays of light efficiently enter the light entrance surface 34.

An AR coating process that is one of anti-reflection processes is performed on the light entrance surface 34 of the light guide plate 18. Accordingly, an AR coating (anti-reflection coating) layer 47 is formed on the light entrance surface 34. The AR coating layer 47 is a thin film made of a material having a low reflective index such as magnesium fluoride or silica. The film thickness of the AR coating layer 47 is set so that the phase of the wavelength of the visible light shifts by ¼ by transmission of the visible light through the AR coating layer 47. With such a film thickness, each of the rays of light reflecting off the surface of the AR coating layer 47 and the rays of light passing through the AR coating layer 47 and reflecting off the light entrance surface 34 have a wavelength whose phase is shifted by a half respectively with a reversed phase. This cancels the reflecting light each other to reduce the amount of reflecting light. As a result, the light entrance efficiency of rays of light into the light entrance surface 34 is further improved. By forming the AR coating layer 47 on the light entrance surface 34, the entrance of beams of light entering the light entrance surface 34 and the reflection of beams of light reflecting off the light entering surface is controlled. This improves the light entrance efficiency of rays of light into the light entrance surface 34. The AR coating layer 47 is formed in a curved shape (a spherical shape) along the light entrance surface 34 and the thickness of the layer is substantially constant over an entire area.

The above-mentioned structure improves the light entrance efficiency of rays of light into the light guide plate 18 and also achieve uniformity in each of the light entrance efficiency and the light exit efficiency with respect to the light guide plate 18. Accordingly, brightness difference is less likely to be caused in each of the light guide plates 18 (each of the divided light exit portions 31S).

The AR coating layer 47 may be formed by overlaying a number of layers each having a thickness appropriate for a wavelength of visible light of each single color R, G, B. A predetermined wavelength is selected and the AR coating layer 47 may be formed of a single layer having a thickness appropriate for the wavelength. The AR coating process includes forming the thin AR coating layer 47 on the light entrance surface 34 with a material having a low reflective index by the vacuum evaporation method.

The light guide plate 18 having the above-mentioned structure is produced as follows. A mold for molding the light guide plate 18 with resin is filled with melted synthetic resin material and the mold is cooled to solidify the material therein. Then, the mold is opened to obtain the light guide plate 18 of a predetermined shape. According to this molding, the light entrance surface of the light guide plate 18 is formed in a recessed spherical shape (in a curved shape). Then, the AR coating process that is the optical process is performed on the light entrance surface 34 having the spherical shape and the AR coating layer 47 having a predetermined thickness is formed with the material having low reflective index by the vacuum evaporation method, as illustrated in FIGS. 11 and 15. At this time, because the light entrance surface 34 is formed in a recessed spherical shape and the LED holding space 33 including the light entrance surface 34 is open rearward, the light entrance surface 34 is bare on the rear side. Therefore, the AR coating process is easily performed on the light entrance surface 34 without requiring a special processing device. This improves performance efficiency and reduces a cost. After the AR coating process is completed, the reflection sheet 24 is adhered on the rear-surface side of the light guide plate 18.

A number of the light guide plates 18 manufactured as described above are provided on the LED boars 17 in the backlight unit 12 according to the above-mentioned arrangement and other components are assembled. If the LED 16 is lit after the light guide plate 18 is mounted to the LED board 17, the light emitted from the LED 16 radiates around the light axis LA three-dimensionally in the X-axis direction and the Z-axis direction. Rays of the light emitting from the light emitting surface 16a pass through the space between the light emitting surface 16a and the light entrance surface 34 and strike the light entrance surface 34a. Because the recessed light entrance surface 34 and the convex light emitting surface 16a have a spherical shape so as to follow each other, rays of the light emitting from the light emitting surface 16a strike the light entrance surface 34 easily from a normal direction. Therefore, the light is less likely to reflect off the light entrance surface 34 to be directed to outside of the light guide plate 18 and the light efficiently enters the light guide plate 18. The AR coating process is performed on the light entrance surface 34 as an anti-reflection process and the AR coating layer 47 is formed thereon. Therefore, even if the beams of light reflect off the surface of the AR coating layer 47, the reflecting light is canceled by the beams of light passing through the AR coating layer 47 and reflecting off the light entrance surface 34. This reduces the amount of reflecting light. This further improves the light entrance efficiency.

As illustrated in FIGS. 7 to 9, the light entering the light guide plate 18 through the light entrance surface 34 travels through the light guide portion 32 toward the light exit portion 31 while totally reflects off the interface between the light guide plate 18 and the external space. With this configuration, the light is less likely to leak to the external space. The light that reaches the light exit portion 31 is scattered by the scattering surface 37 formed on the surface opposite from the light exit surface 36 and reflected by the reflection sheet 24 arranged on the further rear-surface side than the scattering surface 37. Namely, the light is guided to the light exit surface 36. Such light scattered by the scattering surface 37 and reflected by the reflection sheet 24 toward the upper side includes rays that strike the light exit surface 36 at angles smaller than the critical angle. Such rays of the light exit the light guide plate 18 through the light exit surface 36 to the external space. The rays that strike the light exit surface 36 at angles larger than the critical angle are totally reflected by the light exit surface 36 and scattered by the scattering surface 37. The rays repeat such moves and finally exit from the light exit surface 36. The light exit the light guide plate 18 is evenly scattered in a plane created by all of the light exit surfaces 36 in the backlight unit 12 while traveling through the diffusers 15a, 15b and the optical sheet 15c. The light is converted to planar light and illuminates the liquid crystal panel 11.

As explained above, the backlight unit 12 of the present embodiment includes the LED 16 having the light emitting surface 16a and the light guide plate 18 provided to face the light emitting surface 16a and having the light entrance surface 34 and the light exit surface 36. The light emitting from the light emitting surface 16a enters the light entrance surface 34 and the light exits from the light exit surface 36. Each of the light emitting surface 16a and the light entrance surface 34 is formed to be a curved surface and the optical process is performed on the light entrance surface 34.

The light emitting from the light emitting surface 16a enters the light entrance surface 34 of the light guide plate 18. Because the light emitting surface 16a and the light entrance surface 34 are formed in curved surfaces, the light emitting from the LED 16 efficiently enters the light guide plate 18. Further, since the optical process is performed on the light entrance surface 34, the conditions of light entering the light entrance surface 34 or the conditions of light reflecting off the light entrance surface 34 are controlled according to the conditions of the optical process. This improves the light entrance efficiency. The “optical process” is performed on the light entrance surface 34 to change the conditions of light entering the light entrance surface 34 or the conditions of light reflecting off the light entrance surface 34 from the conditions thereof in the case the “optical process” is not performed thereon.

Because the anti-reflection process is performed on the light entrance surface 34 as an optical process, the anti-reflection layer is formed thereon. Due to the formation of the anti-reflection layer on the light entrance surface 34, the amount of light reflecting off the light entrance surface 34 is reduced. This improves the light entrance efficiency of rays of light into the light entrance surface 34.

The anti-reflection layer is the AR coating layer 47 and the AR coating layer 47 is formed on the light entrance surface 34. This reduces the amount of light reflecting off the light entrance surface 34 and this improves the light entrance efficiency of rays of light into the light entrance surface 34. Specifically, the AR coating layer 47 is a thin film made of a material having a low reflective index such as magnesium fluoride. The film thickness of the AR coating layer 47 is set so that the phase of the wavelength of the visible light shifts by 1/4 by transmission of the visible light through the AR coating layer 47. Accordingly, the rays of light reflecting off the surface of the AR coating layer 47 and the rays of light passing through the AR coating layer 47 and reflecting off the light entrance surface 34 have a wavelength whose phase is shifted by a half respectively with a reversed phase. This cancels the reflecting light each other to reduce the amount of reflecting light.

The light emitting surface 16a and the light entrance surface 34 are formed to have an arc-shaped cross section. The light emitting surface 16a is formed to have a convex shape and the light entrance surface 34 is formed to have a recessed shape. Accordingly, the light emitting surface 16a is formed to have a convex shape and an arc-shaped cross section and the light entrance surface 34 is formed to have a recessed shape and an arc-shaped cross section. Therefore, compared to the case in that the light emitting surface 16a and the light entrance surface 34 have a corrugated cross section, the light entrance efficiency of rays of light is improved. Also, the optical process is performed easily on the light entrance surface 34.

The light emitting surface 16a and the light entrance surface 34 have a concentric cross sectional shape. Accordingly, when a gap is provided between the light emitting surface 16a and the light entrance surface 34, the gap is constant and this further improves the light entrance efficiency.

A number of the LEDs 16 and the light guide plates 18 are arranged in series. Accordingly, the optical process is performed on each light entrance surface 34 of the light guide plates 18 to control the conditions of light entering the light entrance surface 34 and the conditions of light reflecting off the light entrance surface 34. This equalizes brightness of each light guide plate 18. Accordingly, brightness difference is less likely to be caused in each light guide plate 18 and uneven brightness is less likely to be caused in the backlight unit 12.

The LEDs and the light guide plates 18 are arranged in series two-dimensionally. Accordingly, the light exit surfaces 36 of the light guide plates 18 are also arranged in series two-dimensionally. This is less likely to cause uneven brightness in the backlight unit 12.

The light exit surface 36 is provided to be parallel to the arrangement direction in which the light emitting surface 16a and the light entrance surface 34 are arranged. Improved brightness is obtained in such an edge-light type (side-light type) backlight device 12.

The LED holding space 33 is formed in the light guide plate 18 so as to receive the LED 16 therein and to be open on the LED 16 side. With such a configuration, the light entrance surface 34 faces the LED 16 in the LED holding space 33. However, since the LED holding space 33 is open on the LED 16 side, the optical process is easily performed on the light entrance surface 34.

The LED 16 is mounted on the LED board 17. A part of the light guide plate 18 including a surrounding portion of the LED holding space 33 and portions on either side of each LED 16 is a board mounting portion 30. With such a configuration, the part of the light guide plate 18 including a surrounding portion of the LED holding space 33 and portions on either side of each LED 16 can be used as amounting structure for mounting the light guide plate 18 to the LED board 17.

Each of the light emitting surface 16a and the light entrance surface 34 has a cross section of a curved surface taken along a surface parallel to the arrangement direction in which the light emitting surface 16a and the light entrance surface 34 are arranged and substantially perpendicular to the light exit surface 36. Each of them also has a cross section of a curved surface taken along a surface parallel to the light exit surface 36. Accordingly, rays of light emitting and radiating three-dimensionally from the LED 16 enter the light entrance surface 34 efficiently, and further high brightness is obtained.

The LED 16 is used as a light source. Therefore, highly improved brightness is obtained.

The liquid crystal display device 10 of the present embodiment includes the above-mentioned backlight unit 12 and the liquid crystal panel 11 providing display using light from the backlight unit 12. According to such a liquid crystal display device 10, the backlight device 12 supplying the liquid crystal panel 11 with light provides high brightness and therefore display with excellent display quality is achieved.

### Second Embodiment

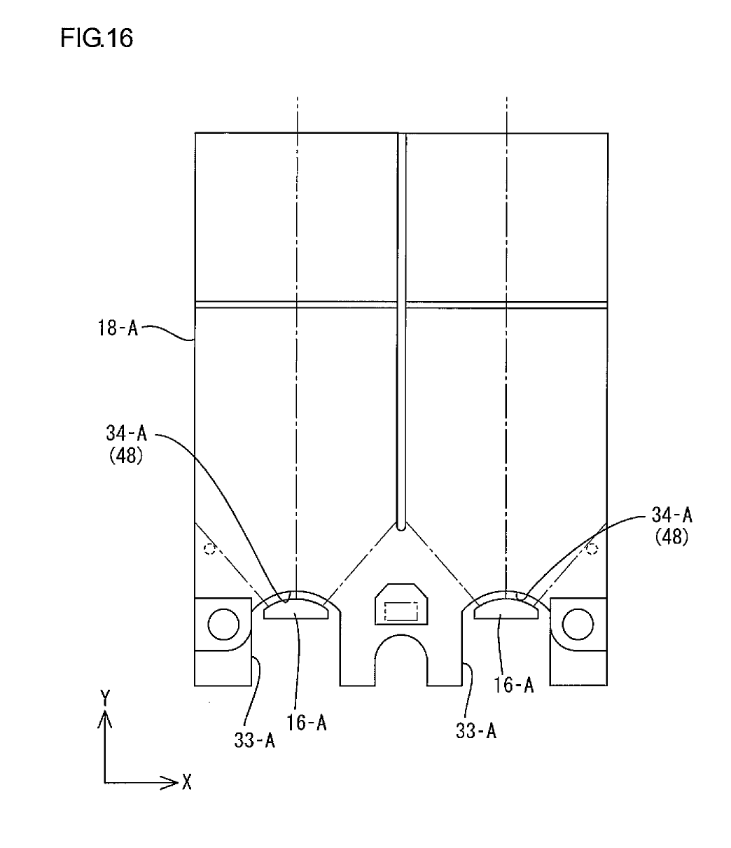

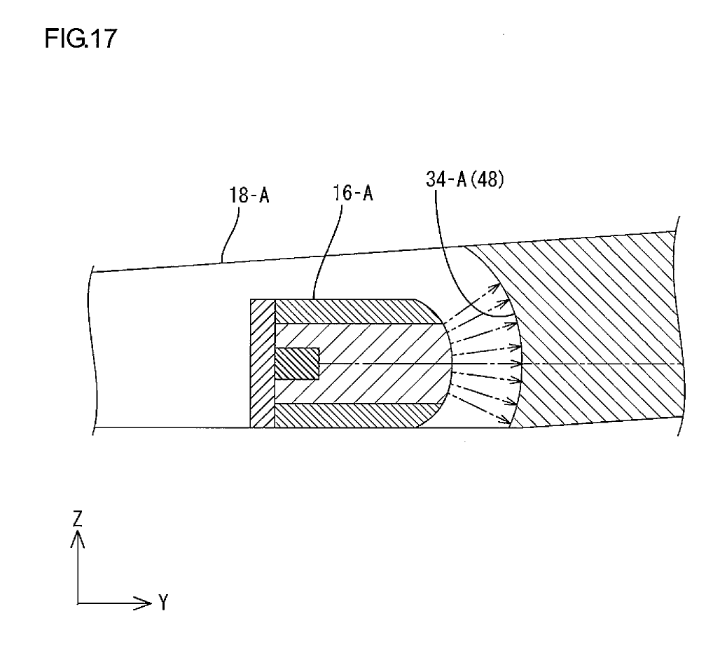

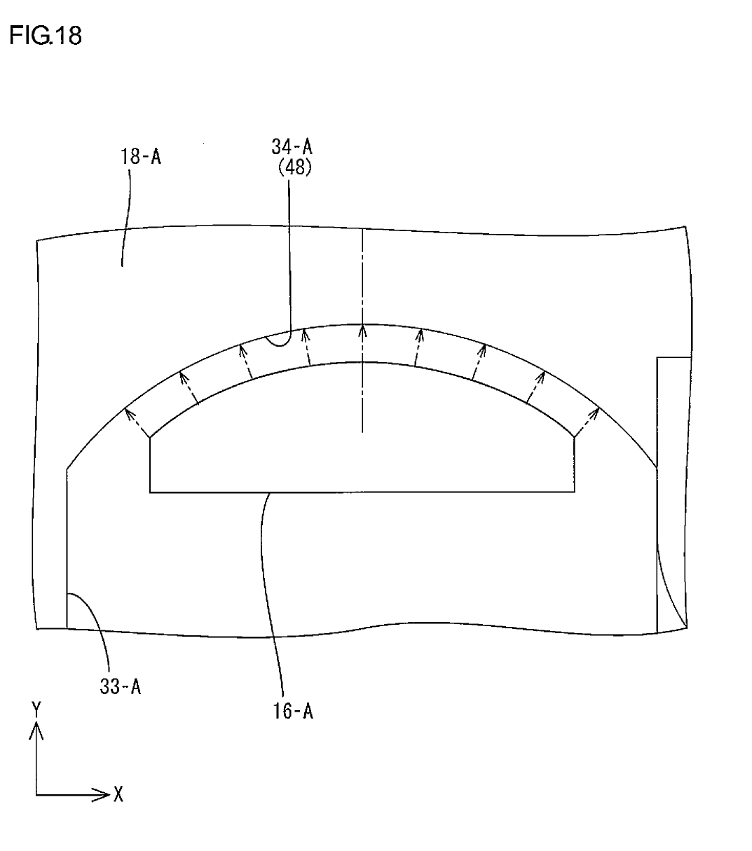

The second embodiment of the present invention will be explained with reference to FIGS. 16 to 18. In the second embodiment, a different optical process is performed on a light entrance surface 34-A. Similar parts to the first embodiment will be indicated by the same symbols followed by -A. The same configurations, functions and effects will not be explained.

In the present embodiment, as illustrated in FIGS. 16 to 18, an abrasive process is performed on the light entrance surface 34-A of a light guide plate 18-A as the optical process. The abrasive process is performed, for example, by rotating an abrasive such as an abrasive wheel set in an abrasive device (both not shown) at high speed and moving it toward the light entrance surface 34-A of the light guide plate 18-A so as to be in contact therewith. At this time, if an abrasive having a surface of a curved shape along an outline of the light entrance surface 34-A is used, the process is efficiently performed and the light entrance surface 34-A is molded to be in a desired shape (having desired smoothness) with high accuracy. After such an abrasive process is performed on the light entrance surface 34-A, a smooth surface 48 with high smoothness is obtained compared to the surface before the performance of the abrasive process (the surface right after the resin molding, the surface on which the abrasive process is not performed). Accordingly, scattered reflections are less likely to occur on the light entrance surface 34-A when the light emitting from the LED 16-A enters the light entrance surface 34-A. This improves the light entrance efficiency and light exit efficiency with respect to the light guide plate 18-A and also improves brightness. An LED holding space 33-A is formed to be open rearward (downward in FIG. 16) and the light entrance surface 34-A is bare on the rear side toward the external space. Therefore, the abrasive process is easily performed without requiring any special abrasive processing device. The method of the abrasive process may be any known method such as sandblasting.

As explained above, according to the present embodiment, the abrasive process is performed on the light entrance surface 34-A as the optical process to form the smooth surface 48. Since the smooth surface 48 is formed on the light entrance surface 34-A, unnecessary scattered reflections are less likely to occur on the surface compared to the case the abrasive process is not performed thereon. Therefore, the light entrance efficiency is improved.

### Third Embodiment

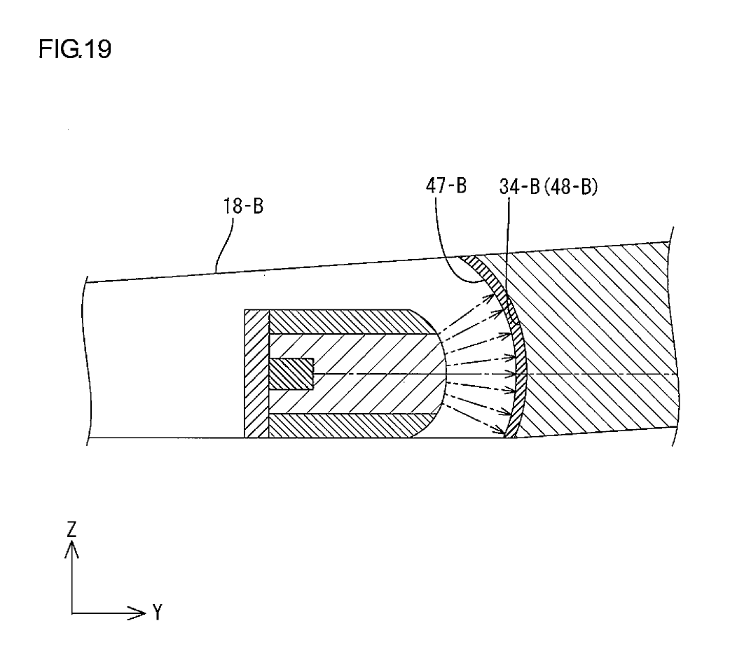

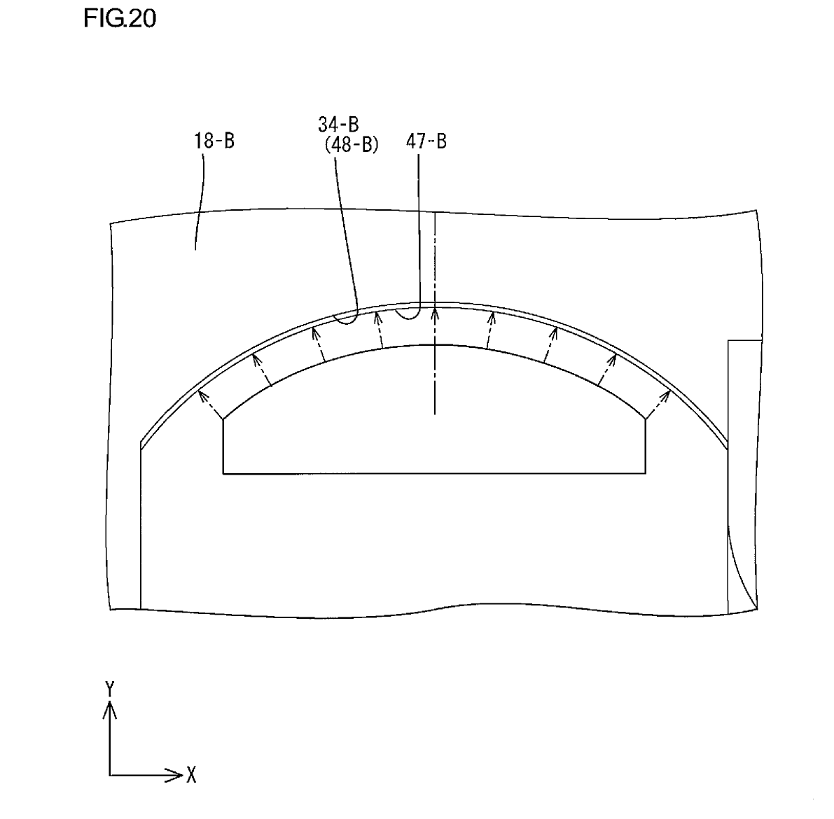

The third embodiment of the present invention will be explained with reference to FIGS. 19 and 20. In the third embodiment, a different optical process is performed on a light entrance surface 34-B. Similar parts to the first and second embodiments will be indicated by the same symbols followed by -B. The same configurations, functions and effects will not be explained.

In the present embodiment, the abrasive process and the AR coating process that are mentioned earlier are performed as the optical process. Specifically, as illustrated in FIGS. 19 and 20, the abrasive process same as the second embodiment is performed on a light entrance surface 34-B of a light guide plate 18-B first to obtain a smooth surface 48-B having high smoothness compared to the surface before the abrasive process. Thereafter, the AR coating process same as the first embodiment is performed on the light entrance surface 34-B that is the smooth surface 48-B to form an AR coating layer 47-B made of a material having a low reflective index. With this configuration, the light passing through the AR coating layer 47 is less likely to cause unnecessary scattered reflections at the light entrance surface 34-B. The light reflecting off the light entrance surface 34-B appropriately cancels the light reflecting off the surface of the AR coating layer 47-B. This efficiently reduces the amount of reflecting light. Accordingly, the light entrance efficiency and the light exit efficiency with respect to the light guide plate 18-B and brightness is further improved.

### Forth Embodiment

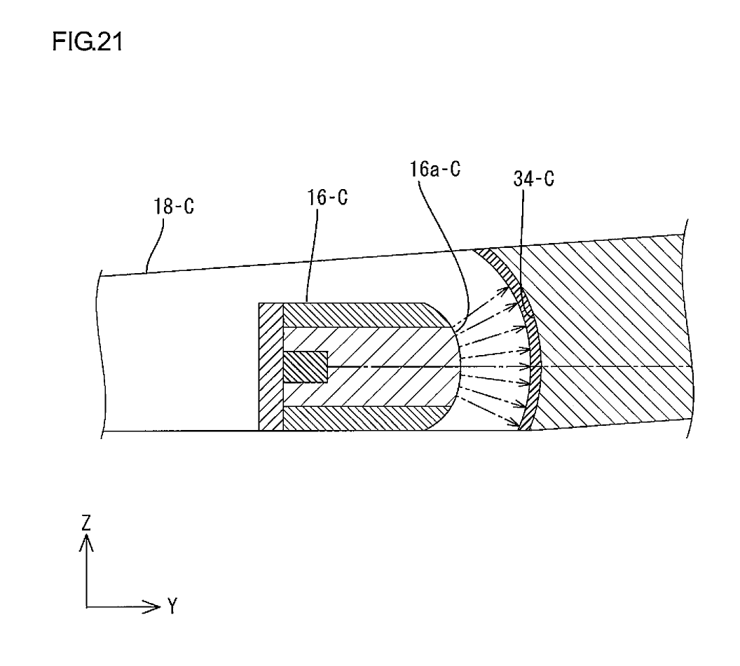

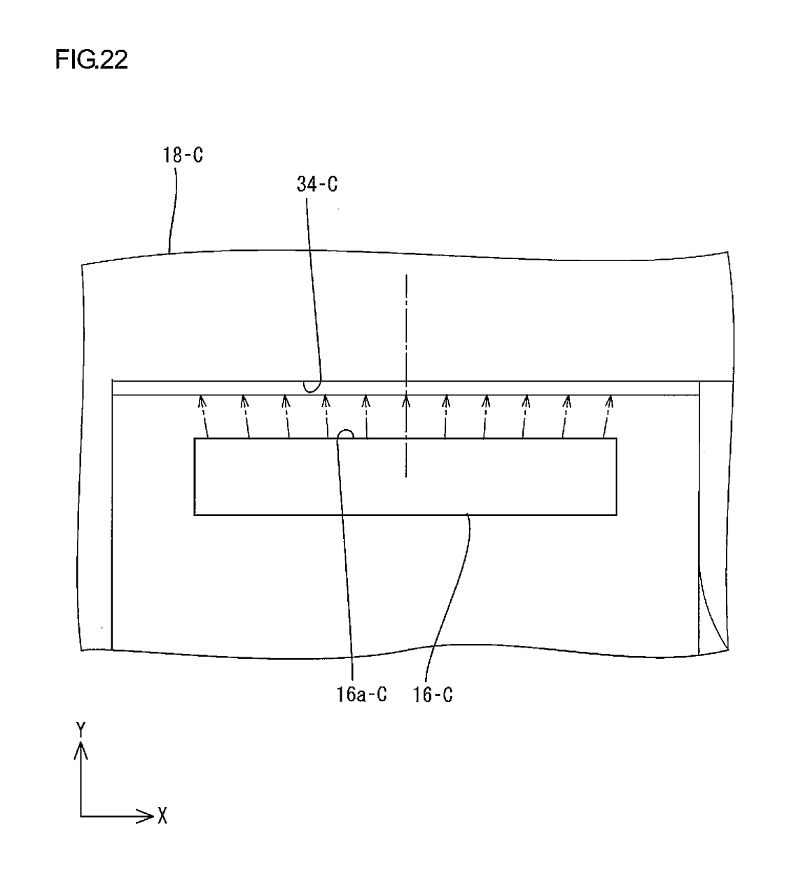

The fourth embodiment of the present invention will be explained with reference to FIGS. 21 and 22. In the fourth embodiment, a light emitting surface 16a-C of an LED 16-C and a light entrance surface 34-C of a light guide plate 18-C are formed in different shapes. Similar parts to the first embodiment will be indicated by the same symbols followed by -C. The same configurations, functions and effects will not be explained.

In the present embodiment, the light emitting surface 16a-C of the LED 16-C and the light entrance surface 34-C of the light guide plate 18-C are formed to have a following shape. As illustrated in FIG. 21, they have a substantially arc-shaped cross section taken along the Y-axis direction and the Z-axis direction, that is, taken along a surface parallel to the arrangement direction in which the light emitting surface 16a-c and the light entrance surface 34-C are arranged and substantially perpendicular to the light exit surface of the light guide plate 18-C. The light emitting surface 16a-C and the light entrance surface 34-C are formed to have the arc-shaped cross section so as to follow each other with a substantially constant space therebetween. Their cross sections taken along the X-axis direction and the Y-axis direction, that is, taken along a surface parallel to the light exit surface are substantially straight along the X-axis direction and parallel to each other, as illustrated in FIG. 22. With the light emitting surface 16a-C and the light entrance surface 34-C having such a shape, the light entrance efficiency is improved. With the light emitting surface 16a-C of the LED 16-C having a substantially straight surface in the X-axis direction, the light directivity in the X-axis direction is improved compared to the one having the arc-shaped surface in the first to third embodiments. The optical process that is to be performed on the light entrance surface 34-C may be selected from the ones described in the first to third embodiments.

As explained above, according to the present embodiment, the light emitting surface 16a-C and the light entrance surface 34-C have a curved cross section taken along a surface parallel to the arrangement direction in which the light emitting surface 16a-C and the light entrance surface 34-C are arranged and perpendicular to the light exit surface of the light guide plate 18-C (a surface along the X-axis direction and the Y-axis direction). Accordingly, the rays of light emitting from the LED 16-C and radiating along a surface along the arrangement direction in which the light emitting surface 16a-C and the light entrance surface 34-C are arranged and substantially perpendicular to the light exit surface (a surface along the Y-axis direction and the Z-axis direction) efficiently enter the light entrance surface 34-C.

### Fifth Embodiment

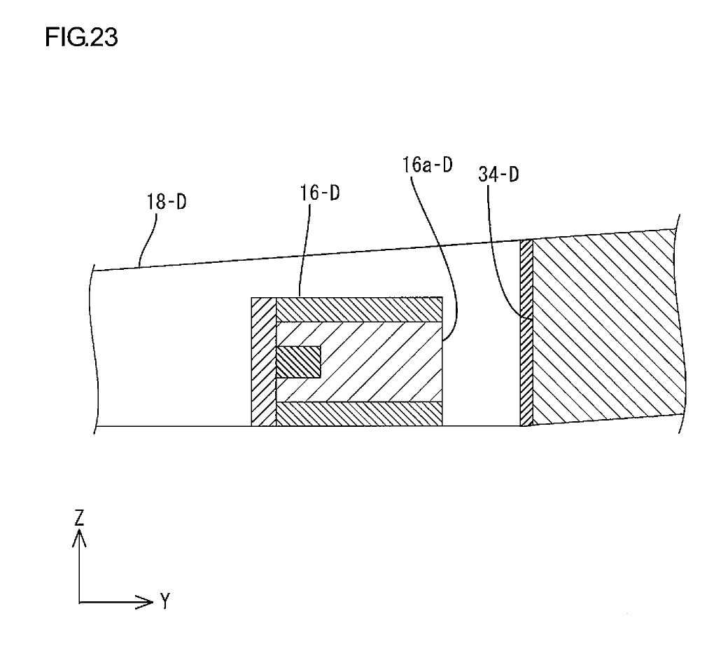

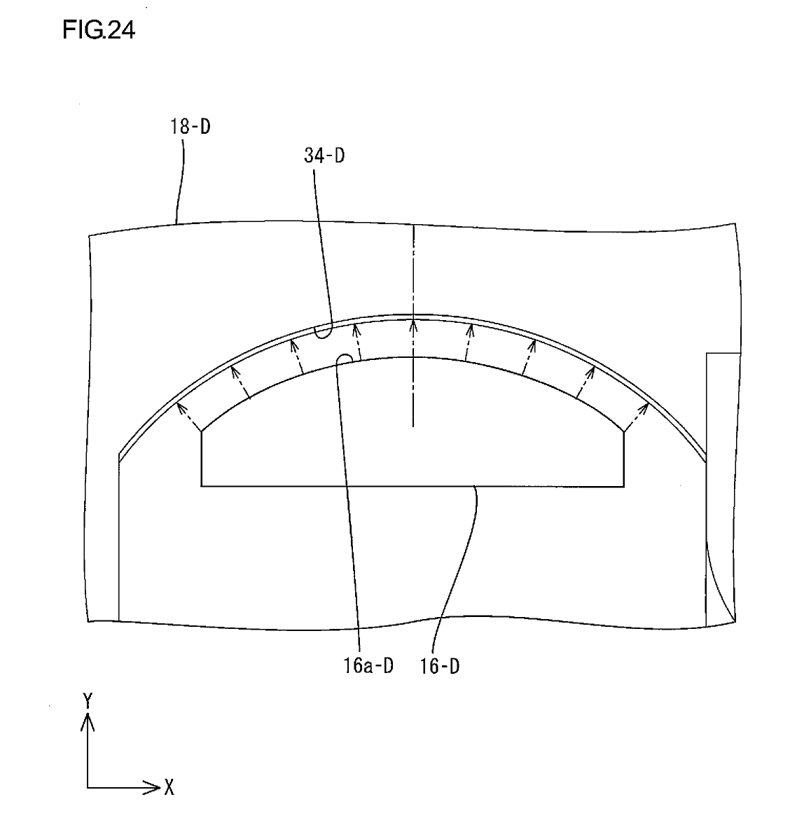

The fifth embodiment of the present invention will be explained with reference to FIGS. 23 and 24. In the fifth embodiment, a light emitting surface 16a-D of a LED 16-D and a light entrance surface 34-D of a light guide plate 18-D are formed in different shapes. Similar parts to the first embodiment will be indicated by the same symbols followed by -D. The same configurations, functions and effects will not be explained.

In the present embodiment, the light emitting surface 165a-d of the LED 16-D and the light entrance surface 34-D are formed to have a following shape. As illustrated in FIG. 24, they have substantially arc-shaped cross sections taken along the X-axis direction and the Y-axis direction, that is, along the surface parallel to the light exit surface. The light emitting surface 16a-D and the light entrance surface 34-D are formed to have the arc-shaped cross section so as to follow each other with a substantially constant space therebetween. Their cross sections taken along the Y-axis direction and the Z-axis direction, that is, along a surface parallel to the arrangement direction in which the light emitting surface 16a-d and the light entrance surface 34-D are arranged and substantially perpendicular to the light exit surface are substantially straight along the X-axis direction and parallel to each other, as illustrated in FIG. 23. With the light emitting surface 16a-D and the light entrance surface 34-D having such a shape, the light entrance efficiency is improved. The optical process that is to be performed on the light entrance surface 34-D may be selected from the ones described in the first to third embodiments.

As explained above, according to the present embodiment, the light emitting surface 16a-D and the light entrance surface 34-D have a curved cross section taken along a surface parallel to the light exit surface. Accordingly, the rays of light emitting from the LED 16-D and radiating along a surface along the light exit surface efficiently enter the light entrance surface 34-D.

### Sixth Embodiment

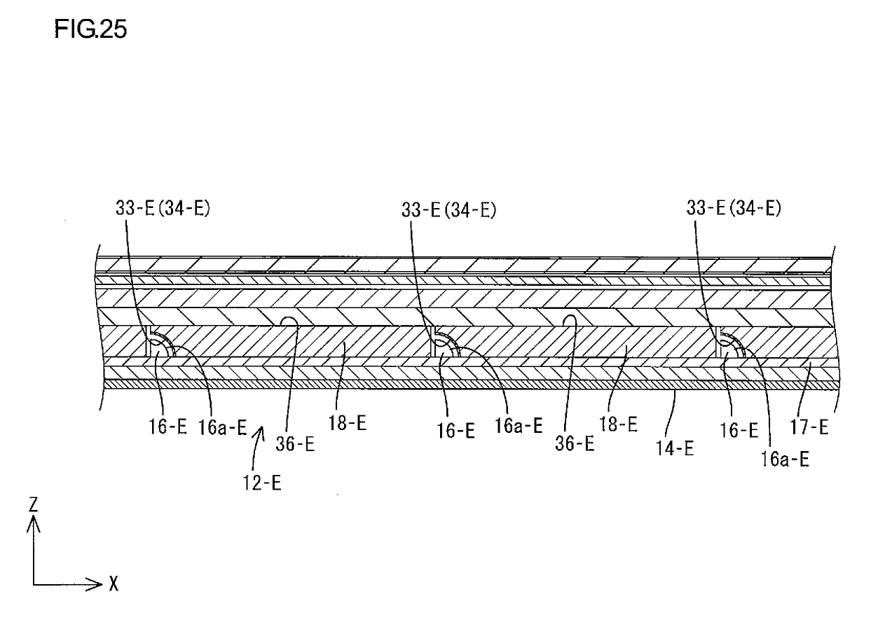

The sixth embodiment of the present invention will be explained with reference to FIG. 25. In the sixth embodiment, a structure of an LED 16-E and a light guide plate 18-E is changed. Similar parts to the first embodiment will be indicated by the same symbols followed by -E. The same configurations, functions and effects will not be explained.

In the present embodiment, as illustrated in FIG. 25, the LED 16-E is provided just below the light guide plate 18-E in a backlight unit 12. Within a chassis 14-E of the backlight unit 12-E, a number of light guide plates 18-E are arranged on an LED board 17-E in a plane arrangement. The adjacent light guide plates 18-E do not overlap each other in a plan view. An LED holding space 33-E that receives the LED 16-E therein is formed in a surface of each light guide plate 18-E facing the LED board 17-E. A peripheral surface of the LED holding space 33-E is a light entrance surface 34 which rays of light emitting from the LED 16-E enter. The LED holding space 33-E is formed at an end of the light guide plate 18-E such that the end of the light guide plate 18-E overlaps the LED 16-E in the plan view. The light emitting surface 16a-E of the LED 16-E and the light entrance surface 34-E of the light guide plate 18-E have cross sections of a curved arc shape. With such an arrangement of the LED 16-E and the light guide plate 18-E, the light entrance efficiency is improved. A light exit surface 36-E of the light guide plate 18-E is substantially perpendicular to the arrangement direction (the Z-axis direction) in which the light emitting surface 16a-E of the LED 16-E and the light entrance surface 34-E of the light guide plate 18-E are arranged. The optical process that is to be performed on the light entrance surface 34-E may be selected from the ones described in the first to third embodiments.

### Other Embodiments

The present invention is not limited to the above embodiments explained in the above description. The following embodiments may be included in the technical scope of the present invention, for example.
(1) In the first embodiment, the anti-reflection process is performed on the light entrance surface as the optical process. Specifically, the AR coating process is performed thereon. However, for example, a surface roughening process may be performed as the anti-reflection process. In the surface roughening process, the light entrance surface may be coated with particles (fine particles) such as silica to form microscopic asperities (a rough surface) thereon.
(2) In the above embodiments, the light emitting surface of the LED and the light entrance surface of the light guide plate are formed to have arc-shaped cross sections and concentrically arranged. However, the light emitting surface and the light entrance surface are formed to have arc-shaped cross sections but may not be concentrically arranged.
(3) In the above embodiments, the light emitting surface of the LED and the light entrance surface of the light guide plate have arc-shaped cross sections. However, the cross section may be formed to have any shape as long as it is formed to be in a curved shape such as a corrugated shape.
(4) In the above embodiments, the light emitting surface of the LED and the light entrance surface of the light guide plate have similar shapes. However, the light emitting surface and the light entrance surface may have cross sections of different shapes. For example, the light emitting surface may have an arc-shaped cross section and the light entrance surface may have a corrugated cross section.
(5) In the above embodiments, each light guide plate has a single slit so as to have two divided light exit portions and two divided light guide portions (light entrance surfaces). However, each light guide plate may have two or more slits so as to have three or more divided light exit portions and three or more light guide portions (light entrance surfaces). With such a configuration, a single light guide plate can collectively covers three or more LEDs. This makes assembly of the backlight unit easier.
(6) In the above embodiments, the light exit portion and the light guide portion of each light guide plate are divided by the slit so as to cover multiple LEDs. That is, a single light guide plate covers multiple LEDs. However, light guide plates without slits and configured to cover respective LEDs (i.e., each having a single light entrance surface) may be used. With such light guide plates, light emitted from an adjacent LED that is not a target LED to cover does not enter a target light guide plate. Therefore, each light guide plate can be optically independent from another.
(7) In the above embodiments, each light guide plate has a rectangular shape in a plan view. However, each light guide plate may have a square shape in a plan view. The lengths, the widths, the thicknesses and the outer surface shapes of each board mounting portion, each light guide portion and each light exit portion can be altered as necessary.
(8) In the above embodiments, each LED emits light upward in the vertical direction. However, the light emitting direction of each LED can be altered as necessary. Namely, each LED can be mounted to the LED board in a suitable position. Specifically, each LED can be mounted to the LED board so as to emit light downward in the vertical direction, or such that the light emitting direction (the light axis) aligned with the horizontal direction. The LEDs with different light emitting directions may be included.
(9) In the edge-light type backlight unit of the above embodiments, the light guide plates are arranged so as to overlap each other in a plan view. However, the light guide plates may be arranged so as not to overlap each other in a plan view.
(10) In the above embodiments, the LEDs and the light guide plates are two-dimensionally arranged parallel to each other inside the chassis. However, they may be one-dimensionally arranged parallel to each other. Specifically, the LEDs and the light guide plates are arranged parallel to each other only in the vertical direction, or they are arranged parallel to each other only in the horizontal direction.
(11) In the above embodiments, the LED holding space is open rearward so that the light entrance surface is bare to the external space on the rear side. However, the LED holding space may be formed in the light guide plate so as to pass therethrough in a thickness direction and have a closed end on the rear side. With such a structure, the light entrance surface is not bare to the external space on the rear side.
(12) In the above embodiments, each LED includes three different LED chips configured to emit respective colors of RGB. However, LEDs each including a single LED chip configured to emit a single color of blue or violet and each configured to emit white light using fluorescent material may be used.
(13) In the above embodiments, each LED includes three different LED chips configured to emit respective colors of RGB. However, LEDs each including three different LED chips configured to emit respective colors of cyan (C), magenta (M) and yellow (Y) may be used.
(14) In the above embodiment, the LEDs are used as point light sources. However, point light sources other than LEDs can be used.
(15) In the above embodiment, the point light sources are used as light sources. However, linear light sources such as cold cathode tubes and hot cathode tubes may be used.
(16) Planar light sources such as organic ELs may be used other than the above embodiments, (14) and (15).
(17) The optical member may be configured differently from the above embodiments. Specifically, the number of diffusers or the number and the kind of the optical sheets can be altered as necessary. Furthermore, a plurality of optical sheets in the same kind may be used.
(18) In the above embodiment, the liquid crystal panel and the chassis are held in the vertical position with the short-side direction thereof aligned with the vertical direction. However, the liquid crystal panel and the chassis may be held in the vertical position with the long-side direction thereof aligned with the vertical direction.
(19) In the above embodiment, TFTs are used as switching components of the liquid crystal display device. However, the technology described the above can be applied to liquid crystal display devices including switching components other than TFTs (e.g., thin film diode (TFD)). Moreover, the technology can be applied to not only color liquid crystal display devices but also black-and-white liquid crystal display devices.
(20) In the above embodiments, the liquid crystal display device including the liquid crystal panel as a display component is used. The technology can be applied to display devices including other types of display components.
(21) In the above embodiments, the television receiver including the tuner is used. However, the technology can be applied to a display device without a tuner.

1. A lighting device comprising:
at least one light source including a light emitting surface; and
a light guide member including a light entrance surface disposed so as to face the light emitting surface and through which light from the light emitting surface enters and a light exit surface through which the light exits,
the light emitting surface and the light entrance surface being formed to be curved and the light entrance surface being processed with an optical process.

2. The lighting device according to claim 1, wherein an anti-reflection layer is formed on the light entrance surface by performing an anti-reflection process as the optical process.

3. The lighting device according to claim 2, wherein the anti-reflection layer is an AR coating layer.

4. The lighting device according to claim 1, wherein a smooth surface is formed on the light entrance surface by performing an abrasive process on the light entrance surface as the optical process.

5. The lighting device according to claim 1, wherein:
the light emitting surface and the light entrance surface are formed to have an arc-shaped cross section; and
the light emitting surface is formed to be in a convex shape and the light entrance surface is formed to be in a recessed shape.

6. The lighting device according to claim 5, wherein the light emitting surface and the light entrance surface are formed to have concentric cross sections.

7. The lighting device according to claim 1, wherein the light source includes a number of light sources and the light guide member includes a number of light guide members and the light sources and the light guide members are arranged in series so as to be parallel to each other.

8. The lighting device according to claim 7, wherein the light sources and the light guide members are arranged two-dimensionally in series.

9. The lighting device according to of claim 1, wherein the light exit surface is provided so as to parallel to an arrangement direction in which the light emitting surface and the light entrance surface are arranged.

10. The lighting device according to claim 9, wherein the light guide member includes a recess configured to hold the light source and open to the light source side.

11. The lighting device according to claim 10, wherein:
the light source is mounted on a circuit board; and
a portion of the light guide member including a surrounding portion of the recess and portions on either side of the light source is a board mounting portion that is to be mounted on the circuit board.

12. The lighting device according to claim 9, wherein the light emitting surface and the light entrance surface are formed to have curved cross sections taken along an arrangement direction in which the light emitting surface and the light entrance surface are arranged and along a surface substantially perpendicular to the light exit surface.

13. The lighting device according to claim 9, wherein the light emitting surface and the light entrance surface are formed to have curved cross sections taken along a surface parallel to the light exit surface.

14. The lighting device according to claim 9, wherein the light emitting surface and the light entrance surface are formed to have curved cross sections taken along an arrangement direction in which the light emitting surface and the light entrance surface are arranged and along a surface substantially perpendicular to the light exit surface and also have curved cross sections taken along a surface parallel to the light exit surface.

15. The lighting device according to claim 1, wherein the light source is a light emitting diode.

16. A display device comprising:
the lighting device according to claim 1; and
a display panel configured to provide display using light from the lighting device.

17. The display device according to claim 16, wherein the display panel is a liquid crystal panel including liquid crystals sealed between a pair of substrates.

18. A television receiver comprising the display device according to claim 16.
